(19) United States
(12) Patent Application Publication
(10) Pub. No.: US 2018/0150264 A1
(43) Pub. Date: May 31, 2018

(54) INFORMATION PROCESSING SYSTEM FOR EXECUTING DOCUMENT READING PROCESSING

(71) Applicant: KYOCERA Document Solutions Inc., Osaka (JP)

(72) Inventors: Takashi OGUMA, Osaka (JP); Toru YASUI, Osaka (JP); Manuel MANALO, Osaka (JP); Chikara YUKI, Osaka (JP)

(73) Assignee: KYOCERA Document Solutions Inc., Osaka (JP)

(21) Appl. No.: 15/827,525

(22) Filed: Nov. 30, 2017

(30) Foreign Application Priority Data
Nov. 30, 2016 (JP) 2016-233050
Nov. 30, 2016 (JP) 2016-233051
Nov. 30, 2016 (JP) 2016-233053

(51) Int. Cl. G06F 3/12; G03G 15/00

(52) U.S. Cl. CPC G06F 3/126; G06F 3/1221; G06F 3/1226; G06F 2206/1508; G06F 3/1285; G03G 15/5075; G06F 3/1229

(57) ABSTRACT

Provides is an information processing apparatus that is capable of efficiently executing a series of tasks related to reading a document. In the information processing system according to the present disclosure a document reading apparatus includes a performance-information-transmitting unit that transmits performance information in accordance with a request from the information processing apparatus. An information processing apparatus includes a performance-information-acquiring unit, a task-sharing unit, and a task-execution-control unit. The performance-information-acquiring unit acquires performance information of the document reading apparatus. The task-sharing unit, in accordance with the performance information that is acquired by the performance-information-acquiring unit, determines which tasks of a series of tasks for data of a document that is read by the document reading apparatus will be executed by an own apparatus and by the document reading apparatus, and shares the tasks. The task-execution-control unit causes tasks that are determined by the task-sharing unit to be tasks that will be executed by the own apparatus to be executed by the own apparatus, and causes tasks that are determined to be tasks that will be executed by the document reading apparatus to be executed by the document reading apparatus, and processes the tasks as a series of tasks.

### INCORPORATION BY REFERENCE

This application is based on and claims the benefit of priority from Japanese Patent Application No. 2016-233050 filed on Nov. 30, 2016, Japanese Patent Application No. 2016-233051 filed on Nov. 30, 2016, and Japanese Patent Application No. 2016-233053 filed on Nov. 30, 2016, the contents of which are hereby incorporated by reference.

### BACKGROUND

The present disclosure relates to an information processing system, and particularly an information processing system for executing a document reading process.

### Related Art

Conventionally, there are image forming apparatuses such as multifunctional peripherals that are capable of printing documents and images.

On the other hand, in a typical example, a dynamic job scheduler of a server that is connected to a computer network and that manages distributed processing by plural printers having a power-saving mode acquires the apparatus information and the operating status of those printers. Then, based on the apparatus information and the operating status, selects a target apparatus for distributed processing, and notifies a task manager of a client PC that is the requesting source of distributed processing.

In this typical example, it is possible to perform distributed processing that takes into consideration the power-saving mode of an apparatus and switching to the power-saving mode.

### SUMMARY

The information processing system according to the present disclosure is an information processing system that includes a document reading apparatus, and an information processing apparatus that is capable of transmitting and receiving data to and from that document reading apparatus. The document reading apparatus includes a performance-information-transmitting unit that transmits performance information in accordance with a request from the information processing apparatus. The information processing apparatus includes a performance-information-acquiring unit, a task-sharing unit, and a task-execution-control unit. The performance-information-acquiring unit acquires performance information of the document reading apparatus. The task-sharing unit, in accordance with the performance information that is acquired by the performance-information-acquiring unit, determines which tasks of a series of tasks for data of a document that is read by the document reading apparatus will be executed by an own apparatus and by the document reading apparatus, and shares the tasks. The task-execution-control unit causes tasks that are determined by the task-sharing unit to be tasks that will be executed by the own apparatus to be executed by the own apparatus, and causes tasks that are determined to be tasks that will be executed by the document reading apparatus to be executed by the document reading apparatus, and processes the tasks as a series of tasks.

The information processing system according to the present disclosure is an information processing system that includes a document reading apparatus that is capable of reading data of a document, and an information processing apparatus that is capable of transmitting and receiving data to and from the document reading apparatus. The document reading apparatus includes a performance-information-transmitting unit, a task-execution-instruction-acquiring unit, an other-apparatus-searching unit, a task-requesting unit, and a task-executing unit. The performance-information-transmitting unit transmits performance information of an own apparatus to the external information processing apparatus that is capable of sharing and executing a series of tasks for data of the document. The task-execution-instruction-acquiring unit, in accordance with the performance information of the own apparatus that is transmitted by the performance-information-transmitting unit, acquires an instruction for the task that is shared with the own apparatus. The other-apparatus-searching unit references the instruction for the task that is acquired by the task-execution-instruction-acquiring unit, and searches whether or not there is a nearby other apparatus that can be requested to execute the tasks that are not shared with and assigned to the own apparatus. The task-requesting unit requests the requestable other apparatus that is found by the other-apparatus-searching unit to execute tasks, and shares the tasks. The task-executing unit executes tasks that are shared with the own apparatus and that are tasks that the task-executing unit has not requested the other apparatus to execute. The information processing apparatus includes a performance-information-acquiring unit, a task-sharing unit, and a task-execution-control unit. The performance-information-acquiring unit acquires the performance information of the document reading apparatus. The task-sharing unit, in accordance with the performance information that is acquired by the performance information-acquiring unit, determines which tasks of the series of tasks for data of a document that is read by the document reading apparatus to execute by the own apparatus and by the document reading apparatus, and shares the tasks. The task-execution-control unit causes tasks that are determined by the task-sharing unit to be tasks that will be executed by the information processing apparatus to be executed by the information processing apparatus, and causes tasks that are determined to be tasks that will be executed by the document reading apparatus to be executed by the document reading apparatus, and processes the tasks as a series of tasks.

The information processing system according to the present disclosure is an information processing system that includes a document reading apparatus, and an information processing apparatus that is capable of transmitting and receiving data to and from the document reading apparatus. The document reading apparatus includes a performance/position-information-transmitting unit that, in accordance with a request from the information processing apparatus, transmits performance information of the document reading apparatus, and position information of the document reading apparatus on a network. The information processing apparatus includes a performance/position-information-acquiring unit, a performance-task-sharing unit, a position-task-sharing unit, and a task-execution-control unit. The performance/position-information-acquiring unit acquires the performance information and the position information of the document reading apparatus. The performance-task-sharing unit, in accordance with the performance information that is acquired by the performance/position-information-acquiring unit, determines which tasks of a series of tasks for data of a document that is read by the document reading apparatus that are not for transmission processing are to be executed by an own apparatus and by the document reading apparatus, and shares the tasks. The position-task-sharing unit, based on the position information that is acquired buy the performance/position-information-acquiring unit, and in accordance with the position of the transmission destination on the network, determines which of the tasks of the series of task that are for transmission processing are to be executed by the own apparatus and by the document reading apparatus, and shares the tasks. The task-execution-control unit causes the tasks that are not for transmission processing to be executed by an apparatus to which tasks are shared with and assigned to by the performance-task-sharing unit, causes the tasks that are for transmission processing to be executed by an apparatus to which tasks are shared with and assigned to by the position-task-sharing unit, and processes the tasks as a series of tasks.

### BRIEF DESCRIPTION OF THE DRAWINGS

FIG. 1 is a system configuration diagram of an information processing system of a first embodiment of an image forming apparatus according to the present disclosure.

FIG. 2 is a block diagram illustrating the control configuration of the server illustrated in FIG. 1.

FIG. 3 is a block diagram illustrating the control configuration of an image forming apparatus illustrated in FIG. 1.

FIG. 4 is a block diagram illustrating the functional configuration of the information processing system illustrated in FIG. 1.

FIG. 5 is a flowchart of a task-sharing-execution process of a first embodiment according to the present disclosure.

FIG. 6 is a concept diagram of an execution example of the task-sharing-execution process illustrated in FIG. 5.

FIG. 7 is a concept diagram of an execution example of the task-sharing-execution process illustrated in FIG. 5.

FIG. 8 is a block diagram illustrating the functional configuration of an information processing system of a second embodiment according to the present disclosure.

FIG. 9 is a flowchart of a task-sharing-request-execution process of a second embodiment according to the present disclosure.

FIG. 10 is a concept diagram of the task-sharing-request-execution process illustrated in FIG. 9.

FIG. 11 is a concept diagram of the task-sharing-request-execution process illustrated in FIG. 9.

FIG. 12 is a system configuration diagram of an information processing system of a third embodiment of an image forming apparatus according to the preset disclosure.

FIG. 13 is a block diagram illustrating the functional configuration of an information processing system of a third embodiment according to the present disclosure.

FIG. 14 is a flowchart of a task-performance-position-sharing-execution process of a third embodiment according to the present disclosure.

FIG. 15 is a concept diagram of an execution example of the task-performance-position-sharing-execution process illustrated in FIG. 14.

FIG. 16 is a concept diagram of an execution example of the task-performance-position-sharing-execution process illustrated in FIG. 14.

FIG. 17 is a concept diagram of an execution example of the task-performance-position-sharing-execution process illustrated in FIG. 14.

FIG. 18 is a concept diagram of an execution example of the task-performance-position-sharing-execution process illustrated in FIG. 14.

### DETAILED DESCRIPTION

### First Embodiment

[System configuration of an Information Processing System X]

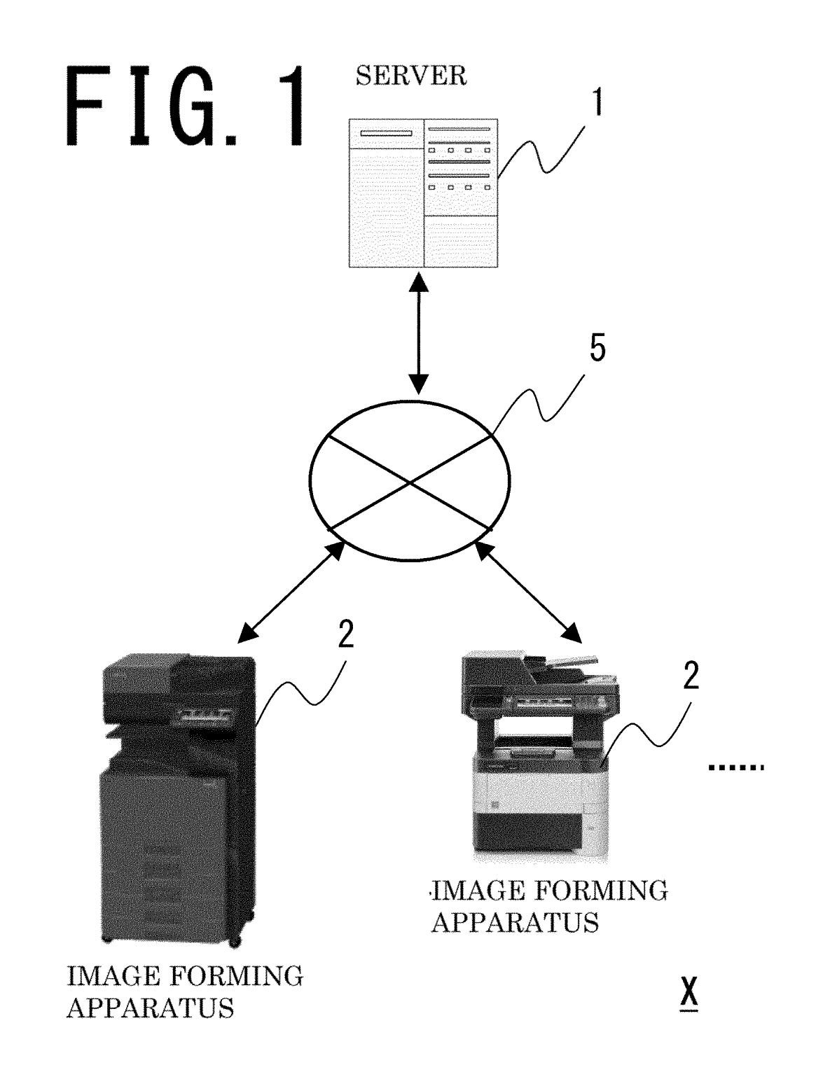

First, the system configuration of an information processing system X will be explained with reference to FIG. 1 to FIG. 3.

The information processing system X of a first embodiment according to the present invention is configured by connecting a server 1 and image forming apparatuses 2 by a network 5.

The server 1 is an information processing apparatus that is capable of transmitting and receiving various data to and from an image forming apparatus 2. In this embodiment, the server 1 is configured using a general-purpose apparatus, a PC or the like, and mainly integrates the function of reading (capturing) a document (text, document) of the image forming apparatuses 2 in a network 5 that is an intranet or the like, as will be explained below. More specifically, the server 1 mainly performs various processing on image data of a document that is captured from an image processing apparatus 2. Even more specifically, the server 1 performs, for example, image processing, OCR processing, classification processing and the like according to the flow of processing that is set as a workflow, as will be described below. Moreover, finally, the server 1 is able to perform transmission processing such as transmission of e-mail, shared folders (folders for saving files, document boxes), or transmission to a DMS or the like for business or office.

An image forming apparatus 2 is a document reading apparatus such as an MFP, network scanner, document scanner, network FAX, printer with a scanner function and the like. An image forming apparatus 2 may execute application software (simply referred to as an “application” below) for connecting to the server 1.

The network 5, in this embodiment, is an intranet or the like that is capable of transmitting and receiving various kinds of data at high speed, and is configured using a LAN, dedicated lines and the like. Moreover, the network 5, via a router, gateway or the like, may also be capable of connecting to a WAN and the like such as the Internet (registered trademark), a portable telephone network and the like, and may also be capable of connecting to another server 1 on a so-called “cloud”. Furthermore, the network 5 may also include a VPN.

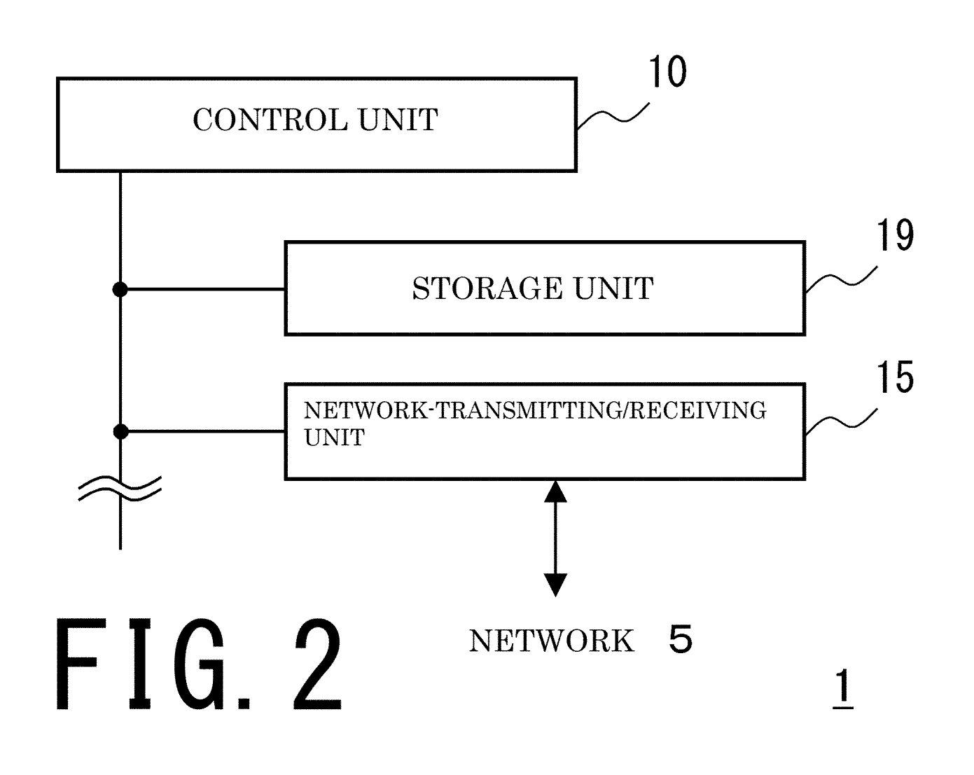

Next, as illustrated in FIG. 2, the server 1 includes a control unit 10, a network-transmitting/receiving unit 15, and a storage unit 19.

The control unit 10 is information-processing means such as a GPP, CPU, DSP, MPU, GPU, ASIC or the like.

The control unit 10, by reading a control program that is stored in the ROM, SSD, HDD or the like of the storage unit 19, expanding the control program in RAM, and executing the control program, operates as each of the units of function blocks described later.

The network-transmitting/receiving unit 15 is network-connecting means that includes an LAN board, a wireless-transmitting/receiving device and the like for connecting to the network 5.

The storage unit 19 is storage means that uses a non-transitory recording medium. The storage unit 19 may include a RAM or the like as a main storage unit. Moreover, the storage unit 19 may include a ROM, an eMMC, a flash memory such as a SSD or the like, an HDD and the like as an auxiliary storage unit. In this case, the control program for performing operation control of image forming apparatuses 2 is stored in the auxiliary storage unit of the storage unit 19.

Furthermore, the storage unit 19 may also include an area for document boxes (folders for saving files, shared folders) for each user.

The storage unit 19 may store information that is related to performance and functions of the server. The storage unit 19 may also include an external storage medium such as various kinds of flash memory, optical recording media and the like.

The control unit 10 may also have built-in RAM, ROM, flash memory and the like.

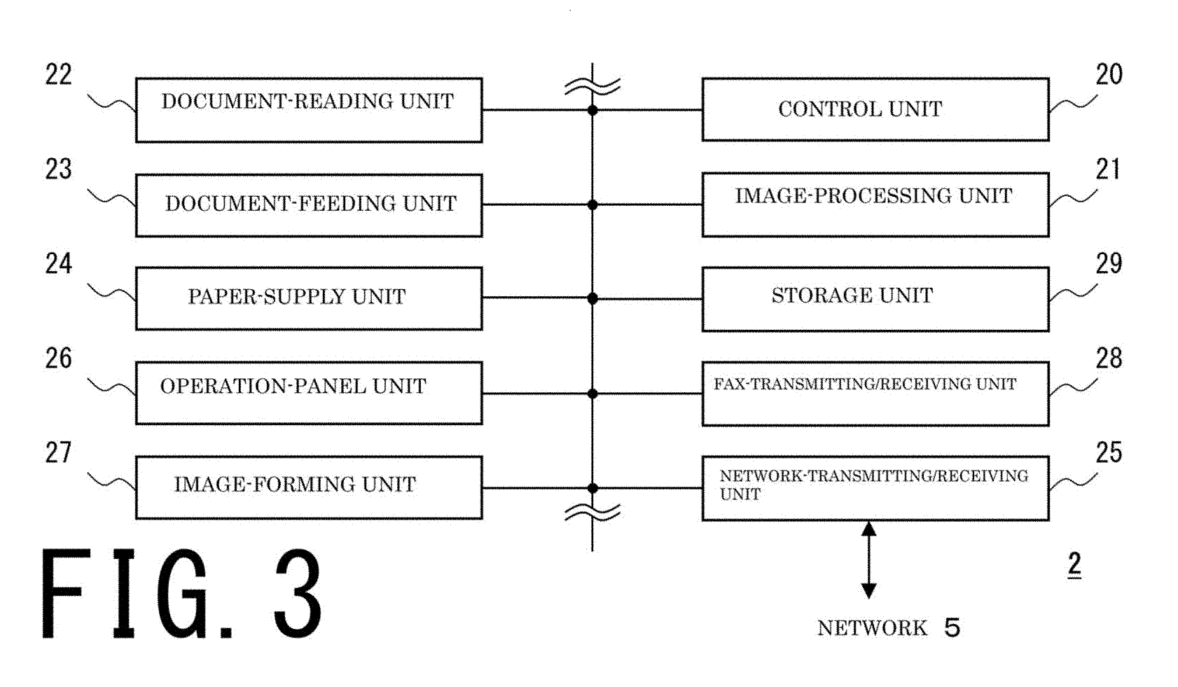

Next, as illustrated in FIG. 3, an image forming apparatus 2 includes an image-processing unit 21, document-reading unit 22, document-feeding unit 23, paper-supply unit 24, network-transmitting/receiving unit 25, operation-panel unit 26, image-forming unit 27 (image forming means), FAX-transmitting/receiving unit 28, storage unit 29 and the like. Each unit is connected to a control unit 20, and the operation is controlled by the control unit 20.

The control unit 20 is information-processing means such as a GPP, CPU, MPU, DSP, GPU, ASIC and the like.

The control unit 20, by reading a control program that is stored in the auxiliary storage unit of the storage unit 29, expanding the control program in the main storage unit, and then executing the control program, operates as each of the means of the function blocks described later. Moreover, the control unit 20 performs overall control of the apparatus according to specified instruction information that is inputted from an external terminal or the operation-panel unit 26.

The image-processing unit 21 is control-operation means such as a DSP, GPU or the like. The image-processing unit 21 is means for performing specified image processing on image data, and, for example, performs various kinds of image processing such as blank-page detection, enlargement, reduction, rotation, density adjustment, tone adjustment, noise reduction, sharpness adjustment, other image improvement and the like.

The image-processing unit 21 stores an image that is read by the document-reading unit 22 in the storage unit 29 as printing data. When doing this, the image-processing unit 21 is also able to convert the printing data in file units using a format such as PDF, TIFF and the like.

Moreover, the image-processing unit 21 may include an OCR function, and an OCR acceleration function. Furthermore, the image-processing unit 21 may have a function for reading barcodes, dot images and the like. In this case, the image-processing unit 21 is able to output text, figures, tables, barcodes, dot images and the like in file units.

The document-reading unit 22 is means for reading (scanning) a set document. Moreover, the document-reading unit 22 is arranged on the top part of the image forming apparatus 2.

The document-reading unit 22 includes a scanner, a platen glass, and a document-reading slit. When reading a document that is placed on the platen glass, the document-reading unit 22 moves the scanner to a position that faces the platen glass, reads and acquires image data while scanning the document that is placed on the platen glass, and outputs the acquired image data to the control unit 20.

Furthermore, when reading a document fed from the document-feeding unit 23, the document-reading unit 22 moves the scanner to a position that faces the document-reading slit. Then, the document-reading unit 22 reads the document, via the document-reading slit, in synchronization with the conveying operation of the document by the document-feeding unit 23, and acquires image data. The document-reading unit 22 outputs the acquired image data to the control unit 20.

The document-feeding unit 23 is means for conveying a document that is to be read by the document-reading unit 22. The document-feeding unit 23 is arranged on the top part of the document-reading unit 22.

The document-feeding unit 23 includes a document-placement unit and a document-conveying mechanism. The document-feeding unit 23 feeds a document that is placed in the document-placement unit in order one sheet at a time by the document-conveying mechanism, and feeds the document to the document-reading unit 22.

The paper-supply unit 24 is means for feeding printing paper toward the image-forming unit 27 one sheet at a time. The paper-supply unit 24 is included in the main unit.

The network-transmitting/receiving unit 25 is network-connecting means, and includes an LAN board, wireless-transmitting/receiving device and the like for connecting to the network 5.

The network-transmitting/receiving unit 25 transmits and receives data by a line for data communication, and transmits and receives audio signals by an audio telephone line.

The operation-panel unit 26 includes an input unit such as buttons, touch panel and the like, and a display unit such as an LCD, organic EL display or the like. Moreover, operation-panel unit 26 is arranged on the front side of the image forming apparatus 2.

The buttons of the input unit of the operation-panel unit 26 includes a numeric keypad, start button, cancel button and buttons for performing operating-mode switch, instruction related to executing a job and the like. The operating mode may include various modes such as copying, FAX transmission, scanner, network scanner and the like. Moreover a job may be a type of job such as printing, transmitting, saving, recording and the like of a selected document. The input unit of the operation-panel unit 26 acquires instructions from a user for various kinds of jobs of the image forming apparatus 2. Furthermore, it is possible to input and change information for each user by a user instruction that is acquired from the operation-panel unit 26.

The image-forming unit 27 is means for performing image formation from data that is stored in the storage unit 29, read by the document-reading unit 22 or acquired from an external terminal to printing paper according to an output instruction from a user.

The image-forming unit 27 includes a photosensitive drum, an exposing unit, a developing unit, a transferring unit, and a fixing unit. The image-forming unit 27 prints a toner image onto printing paper by executing an image-forming process that includes charging, exposing, developing, transferring and fixing.

The FAX-transmitting/receiving unit 28 is means for performing transmission and reception of facsimiles. The FAX-transmitting/receiving unit 28, via an audio telephone line, is able to receive a facsimile from another FAX apparatus, save the facsimile in the storage unit 29, and form an image of the facsimile by the image-forming unit 27. Moreover, the FAX-transmitting/receiving unit 28 is able to convert data of a network FAX that is transmitted from an external terminal or a document that is read by the document-reading unit 22 to image data, and transmit a facsimile to another FAX apparatus via an audio telephone line.

The storage unit 29 is storage means that uses a semiconductor member such as ROM, RAM and the like, or a non-transitory recording medium such as a HDD and the like.

The RAM of the storage unit 29 may maintain stored contents by a function such as self refresh and the like even in the power-saving mode.

The ROM or HDD of the storage unit 29 stores a control program for performing operation control of the image forming apparatus 2. In addition to this, the storage unit 29 may also store user account settings. Moreover, the storage unit 29 may include an area for document boxes (folders for saving files, shared folders) for each user.

In the image forming apparatus 2, the control unit 20 and the image-processing unit 21 may be integrally formed such as in the case of a CPU with built-in GPU or the like, or as in a chip-on-module package.

Moreover, the control unit 20 and the image-processing unit 21 may have built-in RAM, ROM, flash memory and the like.

### [Control Configuration of Information Processing System X]

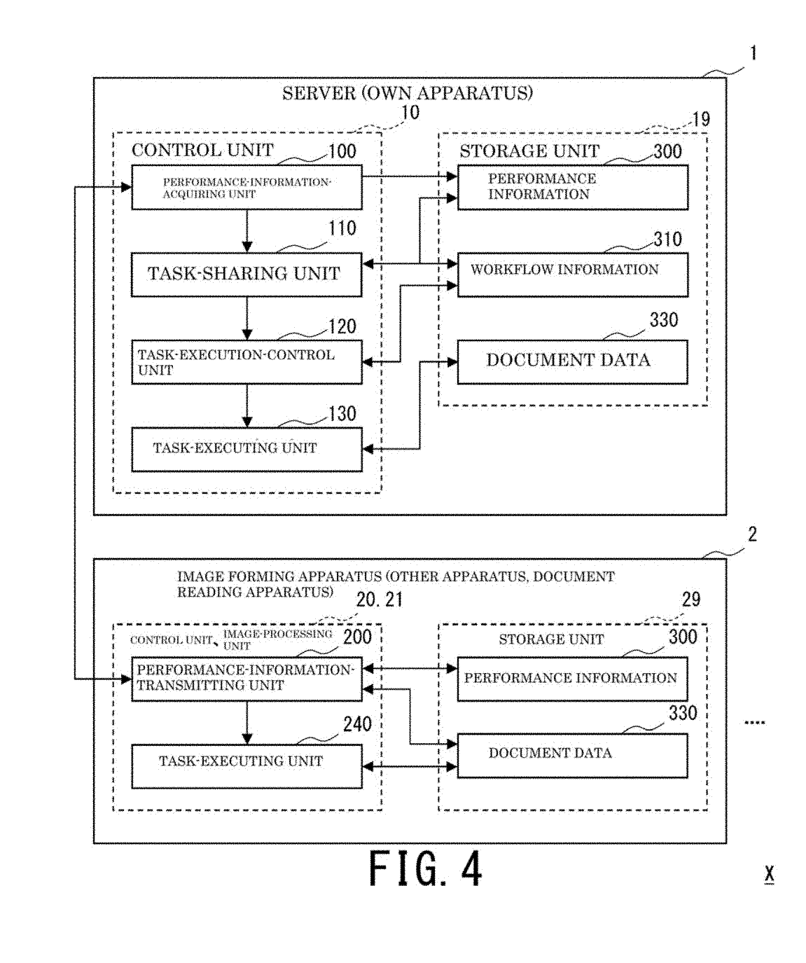

Here, the control configuration of the information processing system X of a first embodiment according to the present disclosure will be explained with reference to FIG. 4.

In the following, an example of performing processing of a workflow of a series of task will be explained with the server 1 taken to be the “own apparatus”, and the image forming apparatus 2 taken to the “other apparatus” (document reading apparatus)

The control unit 10 of the server 1 includes a performance-information-acquiring unit 100, a task-sharing unit 110, a task-execution-control unit 120, and a task-executing unit 130.

The storage unit 19 stores performance information 300 and document data 330 (data of a document), and stores workflow information 310.

The control unit 20 and the image-processing unit 21 of the image forming apparatus 2 include a performance-information-transmitting unit 200 and a task-executing unit 240.

The storage unit 29 stores performance information 300 and document data 330 (data of a document).

The performance-information-acquiring unit 100 acquires performance information 300 of the image forming apparatus 2.

Moreover, in this embodiment, the performance-information-acquiring unit 100 is also able to acquire document data 330 from the image forming apparatus 2, and temporarily store that document data 330 in the storage unit 19. Furthermore, the performance-information-acquiring unit 100 acquires output data for each task of a workflow and temporarily stores that output data in the storage unit 19.

The task-sharing unit 110 determines whether to execute a series of tasks for data of a document that is read by the image forming apparatus 2 by the server 1 or the image forming apparatus 2 and shares the tasks in accordance with workflow information 310 settings, and in accordance with performance information 300 that is acquired by the performance-information-acquiring unit 100. In other words, the task-sharing unit 110 determines whether to execute the task by the server 1 or execute the task by the image forming apparatus 2, and shares the tasks. The task-sharing unit 110, according to performance information 300, may determine to cause the server 1 to execute tasks that are not mounted in the image forming apparatus 2 or that have an execution speed that is slower than by the own apparatus. Furthermore, the task-sharing unit 110 may determine to cause the image forming apparatus 2 to execute tasks that correspond to a function that is mounted in the image forming apparatus 2.

The task-execution-control unit 120 performs an instruction to cause the task-executing unit 130 of the server 1 to execute tasks that have been determined by the task-sharing unit 110 to be executed by the server 1.

Moreover, the task-execution-control unit 120 performs an instruction to cause the task-executing unit 240 of the image forming apparatus 2 to execute tasks that have been determined by the task-sharing unit 110 to be executed by the image forming apparatus 2.

Furthermore, the task-execution-control unit 120 acquires output data of each task that is executed by the server 1 and the image forming apparatus 2, and delivers that output data as the input data for the next task, and performs processing as a workflow of a series of tasks.

The task-executing unit 130 is an executing unit that executes tasks that have been determined by the task-sharing unit 110 to be executed by the server 1 and for which there is an instruction by the task-execution-control unit 120.

The performance-information-transmitting unit 200 transmits performance information 300 to the server 1 in accordance with a request from the server 1.

Moreover, the performance-information-transmitting unit 200 transmits document data 330 that is stored in the storage unit 29 to the server 1.

The task-executing unit 240 is an executing unit that executes tasks that have been determined by the task-sharing unit 110 to be executed by the image forming apparatus 2 and for which there is an instruction by the task-execution-control unit 120.

The performance information 300 is information related to the performance and functions of the image forming apparatus 2. Information that is related to performance and functions that correspond to the respective processing of image processing, OCR processing, classification processing, and transmission processing is set as performance information 300. The performance information 300, for image processing, includes, for example, information such as whether there is a function capable of executing processes such as skipping blank pages, sharing pages, deskewing (automatic skew correction), border removal, contrast adjustment, noise reduction and the like, and information about the processing capacity and performance of those functions. Moreover, the performance information 300, for OCR processing, includes, for example, information regarding languages for which character recognition is possible, resolution, whether or not there is recognition of handwritten characters, whether or not tables and figures can be recognized, version of the recognition engine, recognition speed and the like. Moreover, the performance information 300 includes as OCR processing, for example, information of whether or not one-dimensional, two-dimensional, and/or color barcodes, dot images and the like can be recognized. Furthermore, the performance information 300, for classification processing, includes, for example, information regarding whether or not it is possible to classify invoices, slips, billing and the like, acquire items, extract metadata and the like, and when possible, the type and the like. Of these, metadata includes information of whether or not it is possible to acquire information about the customer ID, company name, name, amount of each item, tax, and the like, and when possible the type and the like. Moreover, the performance information 300, for transmission processing, for example, includes information of the e-mail addresses of users or group, addresses of document boxes (folders for saving files, shared folders), or application name, address, account ID and the like of a DMS.

As performance information 300, it is possible to include information on whether the respective processing described above is possible or not depending on the hardware state, differences in versions of firmware, whether or not an application is installed, state of license authorization and the like. In other words, in the case that a function may not be used even though the model of the image forming apparatus 2 itself includes that function, the performance information 300 may include information to that effect.

Moreover, performance information 300 may also include the language setting, model name, serial number, installation location, customer information and other information of the image forming apparatus 2.

The workflow information 310 is information that includes settings for the flow of processing for a “workflow” of a series of tasks for which the user gives an execution instruction. When this workflow is a scanning workflow related to capture of a document, for example, the workflow information 310 includes settings for the order of processing of tasks of image processing, OCR processing, classification processing, transmission process, settings for the parameter of each respective task, and the like. The workflow information 310, for example, may also include a description of these settings in a format such a “macro” or script.

Moreover, in the workflow information 310 it is possible to set from an application or from the server 1 the administrator of the image forming apparatus 1, the administrator of the server 1 and the like.

The document data 330 is data that is the target of various processing in the workflow. In this embodiment an example is described in which the document data 330 is image data of a document that is read by the document-reading unit 22 of the image forming apparatus 2. The image data, for example, may be bitmap data such as BMP and the like, compressed bitmap data such as TIFF, jpg and the like, PDF data and the like. Moreover, the document data 330 may be a collection of image data in page units, and my be data to which various text data or intermediate data are added in accordance to the degree of progress of each of the tasks described above. The document data 330 may also be a collection of plural files instead of a single file. Furthermore, the document data 330 may be PDF data or the like that is saved beforehand in a document box of a user of the user of the image forming apparatus 2 or the server 1, or that is acquired from a terminal or the like.

Here, the control unit 10 of the server 1 is made to function as the performance-information-acquiring unit 100, the task-sharing unit 110, the task-execution-control unit 120 and the task-executing unit 130 by executing the control program that is stored in the storage unit 19.

Moreover, the control unit 20 of the image forming apparatus 2 is made to function as the performance-information-transmitting unit 200 and the task-executing unit 240 by executing the control program that is stored in the storage unit 29.

Furthermore, each of the units of the server 1 and the image forming apparatus 2 described above is a hardware resource for executing the image forming method according to the present disclosure.

### [Task Sharing Execution Process by Information Processing System X]

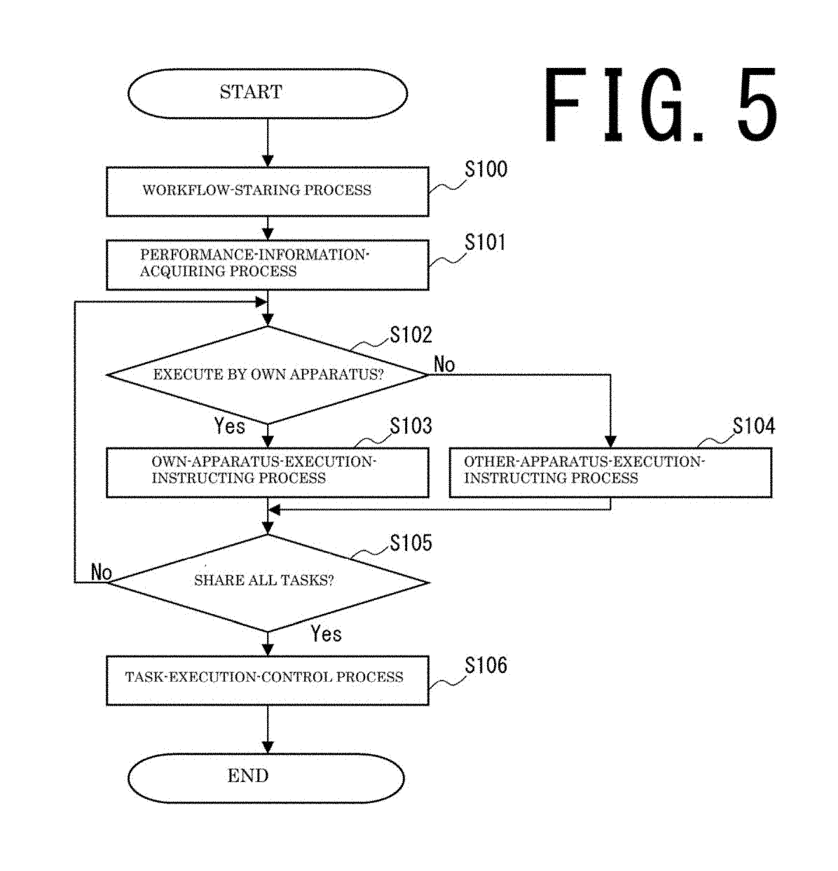

Next, an explanation of the task-sharing-execution process by the information processing system X of a first embodiment according to the present disclosure will be performed with reference to FIG. 5.

In the task-sharing-execution process of this embodiment, the server 1 acquires performance information 300 of the image forming apparatus 2. Then, in accordance with the acquired performance information, the server 1 determines for each of the respective tasks of the workflow for the document data 330 that is read by the image forming apparatus 2 whether to execute the task by the server 1 or execute the task by the image forming apparatus 2, and shares the tasks. After that, the task-sharing-execution process processes the series of tasks by causing the server 1 to execute tasks for which execution by the server 1 is determined, and cause the image forming apparatus 2 to execute tasks for which execution by the image forming apparatus 2 is determined.

In the task-sharing-execution process of this embodiment, mainly the control unit 10 executes a program that is stored in the storage unit 19, and the control unit 20 and image-processing unit 21 execute a program that is stored in the storage unit 29, by working together with each of the units and using the hardware resources.

In the following, the task-sharing-execution process will be explained in detail for each step with reference to the flowchart in FIG. 5.

### (Step S100)

First, the performance-information-transmitting unit 200 of the image forming apparatus 2 performs a workflow-starting process.

Here, when a user instruction to execute a workflow is acquired from the operation-panel unit 26 of the image forming apparatus 2 or from a terminal, the performance-information-transmitting unit 200 transmits a workflow execution command to the server 1.

Moreover, when performing capturing by the image forming apparatus 2, capturing the document is performed by the document-reading unit 22, and temporarily stored in the storage unit 29 as document data 330 of bitmap data. This capturing may be performed in parallel with execution of tasks explained below.

### (Step S101)

Next, the performance-information-acquiring unit 100 of the server 1 and the performance-information-transmitting unit 200 of the image forming apparatus 2 perform a performance-information-acquiring process.

The performance-information-acquiring unit 100 of the server 1 acquires a workflow execution command, and then instructs the performance-information-transmitting unit 200 of the image forming apparatus 2 to transmit performance information 300.

The performance-information-transmitting unit 200 of the image forming apparatus 2 acquires that instruction and transmits the performance information 300 that is stored in the storage unit 29 to the server 1.

The performance-information-acquiring unit 100 of the server 1 acquires the performance information 300 that is transmitted from the performance-information-transmitting unit 200 of the image forming apparatus 2, and stores the performance information 300 in the storage unit 19.

### (Step S102)

Next, the task-sharing unit 110 of the server 1 determines whether or not to execute each of the tasks by the server 1. The task-sharing unit 110 references the workflow information 310 and the acquired performance information 300, and for each task, determines whether or not execution of the task of the workflow can be executed by the image forming apparatus 2, then determines the execution time, the scale and the type of the task, and determines whether execution would be better by the own apparatus or by the other apparatus. When doing this, the task-sharing unit 110, when sharing tasks, may also take into consideration the performance of the server 1 and the image forming apparatus 2, and the transmitting/receiving speed via the network 5.

When doing this, the task-sharing unit 110 may determine according to the performance information 300 to cause the server 1 to execute tasks that are not mounted in the image forming apparatus 2 or that have an execution speed slower than the server 1. More specifically, for tasks that are related to image processing, OCR processing, and transmission processing, and when the image forming apparatus 2 does not have a function that is capable of executing the task, or when the image forming apparatus 2 has that function but is not able to use the function, the task-sharing unit 110 determines to execute the task by the own apparatus. Moreover, depending on the degree of the processing performance, the transmitting/receiving speed, the performance of the server 1 and the like, when executing the task by the server 1 would result in a faster total processing time or higher processing efficiency, the task-sharing unit 110 may determine to execute the task by the own apparatus.

Furthermore, the task-sharing unit 110 may determine to cause the image forming apparatus 2 to execute tasks that correspond to functions that are mounted in the image forming apparatus 2. More specifically, for tasks related to image processing, OCR processing, and transmission processing, for example, when the image forming apparatus 2 has a function capable of executing the task, the task-sharing unit 110 determines to execute the task by the other apparatus.

When the image forming apparatus 2 has a function that is capable of executing the task, but is unable to use that function, the task-sharing unit 110 may temporarily enable use of the function, and then determine to execute the task by the image forming apparatus 2. In other words, the task-sharing unit 110 may enable use of the function by temporarily giving license for the application of the image forming apparatus 2 corresponding to that function, or temporarily installing the application itself. After that, when it becomes possible to use the function, the task-sharing unit 110 determines to execute the task by the image forming apparatus 2.

Here, when the task-sharing unit 110 determines to execute the task by server 1, or in other words, determines to share the task with the server 1, the task-sharing unit 110 determines YES. Otherwise, in other cases, the task-sharing unit 110 determines NO.

In the case of YES, the task-sharing unit 110 advances the process to step S103.

In the case of NO, the task-sharing unit 110 advances the process to step S104.

### (Step S103)

In the case of a task for which it is determined that execution will be performed by the own apparatus, the task-sharing unit 110 performs a own-apparatus-execution-instruction process.

The task-sharing unit 110 instructs the task-execution-control unit 120 to execute the task by the server 1. More specifically, the task-sharing unit 110 sets the macro or script of a task command for executing the task by the server 1. When doing this, the task-sharing unit 110 may set this macro or script by including a setting for the input data and output data that corresponds to the various parameters that are included in the workflow information 310, and a setting indicating that the task will be executed by the own apparatus. Moreover, when doing this, the task-sharing unit 110 may set a “pipe” as that macro or script so that the input data and output data are inputted and outputted in order in accordance with the workflow.

### (Step S104)

In the case of a task for which it is determined that execution will be performed by the other apparatus, the task-sharing unit 110 performs an other-apparatus-execution-instruction process.

The task-sharing unit 110 instructs the task-execution-control unit 120 to execute the task by the image forming apparatus 2. In this process as well, the task-sharing unit 110 may set a macro, script or pipe that incudes a setting for the input data and output data that corresponds to the various parameters that are included in the workflow information 310, and a setting indicating that the task will be executed by the other apparatus.

### (Step S105)

Next, the task-sharing unit 110 determines whether or not the sharing of tasks with the own apparatus or other apparatus has been set for all of the tasks. When sharing has been set for all of the tasks, the task-sharing unit 110 determines YES. Otherwise, in other cases, the task-sharing unit 110 determines NO.

In the case of YES, the task-sharing unit 110 advances the process to step S106.

In the case of NO, the task-sharing unit 110 returns the process to step S102, and shares the remaining tasks of the workflow to be executed by the own apparatus or the other apparatus.

The steps S102 to S105 of this process are the task-sharing process of this embodiment.

### (Step S106)

Here, the task-execution-control unit 120 performs a task-execution-control process.

The task-execution-control unit 120 performs an instruction to cause the tasks for which the task-sharing unit 110 determined to be executed by the own apparatus or the other apparatus to be executed by respective apparatus. More specifically, for example, the task-execution-control unit 120 issues the macro or script commands described above in the order of the settings in the workflow information 310, and distributes execution of the tasks to be executed by the server 1 or the image forming apparatus 2. For example, the task-execution-control unit 120 issues a task command for a task for which it has been determined by the task-sharing unit 110 that execution will be performed by the server 1, and causes the own apparatus to execute that task by the task-executing unit 130. Moreover, for example, the task-execution-control unit 120 issues a task command for a task for which it has been determined by the task-sharing unit 110 that execution will be performed by the image forming apparatus 2, and causes the image forming apparatus 2 to execute that task by the task-executing unit 240.

As a result, the document data 330 is processed, and input data and output data are exchanged between the server 1 and the image forming apparatus 2. When doing this, the task-execution-control unit 120, in accordance with the pipe, may acquire output data that is a result of execution of each of the tasks, and deliver that output data as input data for the next task. As a result, the task-execution-control unit 120 causes each of the tasks to be processed as a workflow of a series of tasks. The task-execution-control unit 120 may create and transmit and receive temporary files as this input data and output data, or may transmit and receive data in specified units such as pages or the like of the document data 330.

This ends the task-sharing-execution process of a first embodiment according to the present disclosure.

[Example of the Task-sharing-execution Process]

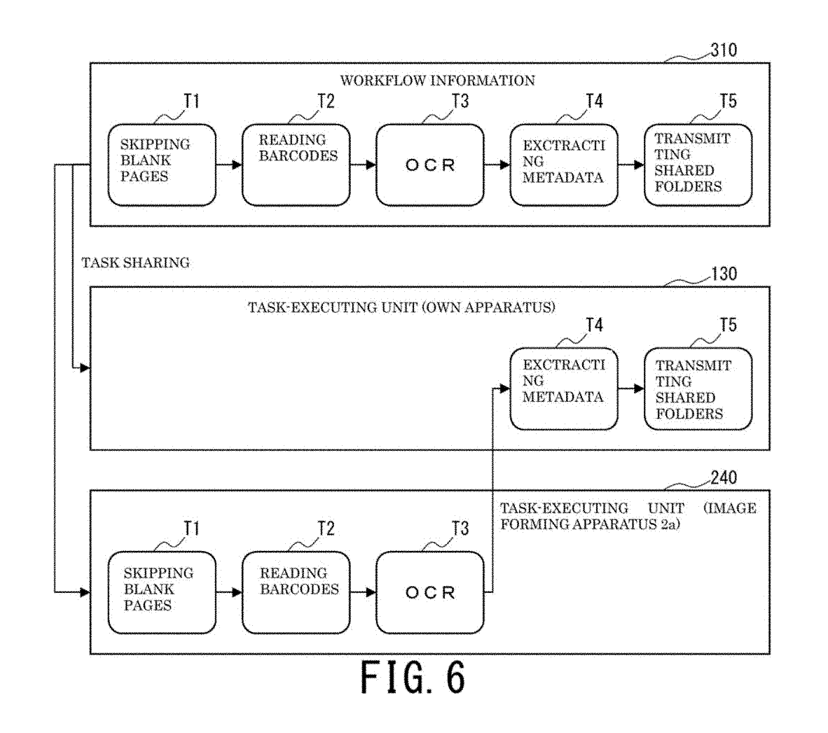

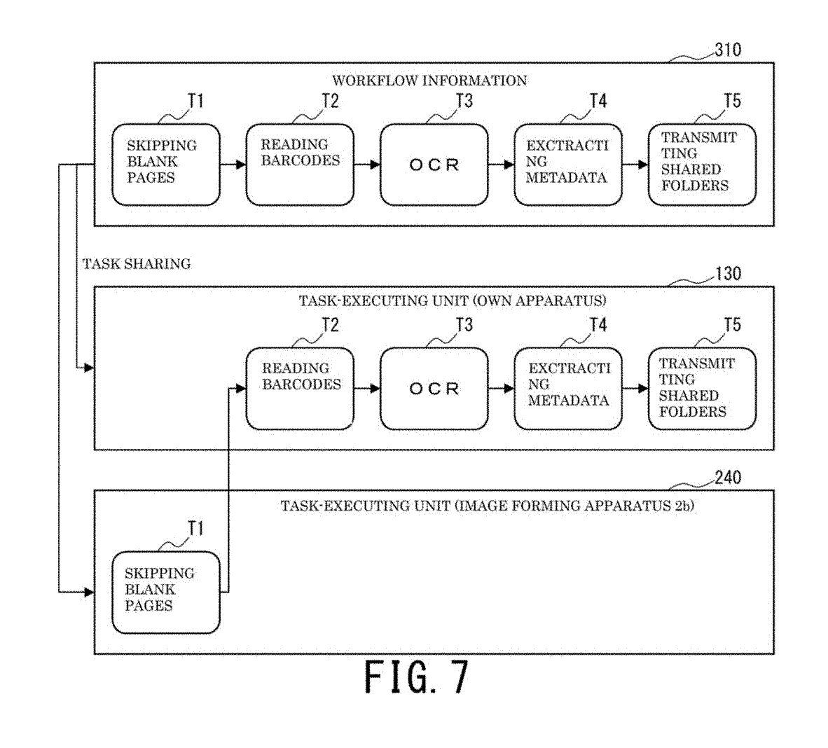

Here, a detailed example of the task-sharing-execution process of a first embodiment according to the present disclosure will be explained with reference to FIG. 6 and FIG. 7.

FIG. 6 illustrates an example in which, for each of the tasks T1 to T5 that are included in the workflow information 310, the series of tasks of the workflow information 310 are shared and executed by the server 1 (own apparatus) and the image forming apparatus 2a (other apparatus).

In this example, the image forming apparatus 2a is a high-function apparatus that is able to use each function of image processing and OCR processing. Therefore, task T1 of skipping blank pages related to image process, task T2 of reading barcodes that are related to OCR processing, and task T3 of OCR are executed in order by the task-executing unit 240 of the image forming apparatus 2a. In this case, task T2 and task T3 may be executed simultaneously by multitasking or the like.

After execution of task T1 to task T3 by the image forming apparatus 2a is complete, the resulting output file is delivered to the task-executing unit 130 of the server 1. Then, task T4 of extracting metadata, and task T5 of transmitting a shared folder that are related to classification processing are executed in order by the task-executing unit 130 of the server 1.

As a result, the list of workflow can be executed with increased processing speed and efficiency by using the server 1 and the high-function image forming apparatus 2a than when executed by one of these alone.

FIG. 7 illustrates an example in which, for each of the tasks T1 to T5 that are included in the same workflow as in FIG. 6, the series of tasks of the workflow information 310 are shared and executed by the server 1 (own apparatus) and an image forming apparatus 2b (other apparatus).

In this example, the image forming apparatus 2b is an apparatus having lower function than the image forming apparatus 2a, and does not have each function for image processing and OCR processing. Therefore, only task T1 of skipping blank pages related to image process is executed by the image forming apparatus 2b, after which the image data and the like that is outputted is delivered to the task-executing unit 130 of the server 1. The remaining tasks T2 to T5 are then executed in order by the task-executing unit 130 of the server 1.

As a result, even in the case of the low-function image processing apparatus 2b, it is possible to execute the listed workflow with increased processing speed and efficiency while sharing with the server 1.

By using this kind of configuration, it is possible to obtain the following effects.

The system of a typical example performs distributed processing in order to save energy, so the actual waiting time for executing a job becomes long.

Moreover, in typical technology, all of the tasks of a workflow can only be executed by the server or by the image forming apparatus, and the actual waiting time becomes long.

However, the information processing system X of a first embodiment according to the present disclosure includes an information processing apparatus 2 that is a document reading apparatus, and a server 1 that is an information processing apparatus that is capable of transmitting and receiving data to and from the image forming apparatus 2 via a network 5. Moreover, the image forming apparatus 2 includes a performance-information-transmitting unit 200 that transmits performance information 300 in accordance with an request from the server 1. Furthermore, the server 1 includes a performance-information-acquiring unit 100, a task-sharing unit 110, and a task-execution-control unit 120. The performance-information-acquiring unit 100 acquires performance information 300 of the image forming apparatus 2. The task-sharing unit 110, in accordance with the performance information that is acquired by the performance-information-acquiring unit 100, determines whether to execute the tasks of a series of tasks for data of a document that is read by the image forming apparatus 2 by the own apparatus or execute the tasks by the image forming apparatus 2, and shares the tasks. The task-execution-control unit 120 processes the series of tasks by causing the own apparatus to execute the tasks that are determined by the task-sharing unit 110 to be executed by the own apparatus, and causing the image forming apparatus 2 to execute the tasks that are determined by the task-sharing unit 110 to be executed by the image forming apparatus 2.

By using this kind of configuration, it is possible to make execution of the series of tasks more efficient, and it is possible to reduce the waiting time. More specifically, it s possible to make the execution time of all of the tasks of a workflow faster than when the server 1 or the image forming apparatus 2 executes the tasks alone, and it is possible to reduce the processing load on the image forming apparatus 2 and the server 1. In other words, it is possible to transmit the performance of the image forming apparatus 2 to the server 1, and in accordance with the performance of the image forming apparatus 2, it is possible to share and execute the tasks of a workflow as tasks for the image forming apparatus 2 and tasks for the server 1. As a result, it is possible to improve the overall availability of the image forming apparatus 2 and the server 1 on the network 5.

Moreover, by causing the server 1 to execute OCR tasks, it becomes possible even for an image forming apparatus 2 that does not have a built-in OCR function to execute a workflow that includes OCR.

Furthermore, in the server 1 of a first embodiment according to the present disclosure, the task-sharing unit 110, according to the performance information 300, causes the server 1 to execute tasks that are not mounted in the image forming apparatus 2, or that have a slower execution speed than by the own apparatus. Then, the task-sharing unit 110 determines to cause the image forming apparatus 2 to execute tasks that correspond to functions that are mounted in the image forming apparatus 2.

By using this kind of configuration, it is possible to make execution of a series of tasks more efficient, and it is possible to execute the tasks faster than when executed by the server 1 or by the image forming apparatus 2 alone, and it is possible to reduce the processing load.

### Other Embodiments

In the first embodiment according to the present disclosure, sharing a series of tasks by the own apparatus and the other apparatus was described, however, depending on the performance of the other apparatus, the entire series of tasks may be executed by either of the apparatuses. In other words, in the case of a low-function image forming apparatus, a network scanner or the like that does not have a function such as skipping blank pages as a function related to image processing, the entire series of tasks may be executed by the server. Moreover, in the case of a high-function image forming apparatus 2 that is capable of executing at high speed all of the functions of image processing, OCR processing, classification processing, transmission processing, the entire series of tasks may be executed by the image forming apparatus 2.

By using this kind of configuration, it is possible to execute a series of tasks with optimum efficiency and speed in accordance with the environment of the own apparatus and the other apparatus.

### Second Embodiment

### [System Configuration of Information Processing System X]

The information processing system X of a second embodiment according to the present disclosure, as in the case of the information processing system X of the first embodiment, is configured by a server 1 and information processing apparatus 2 that are connected by a network 5.

### [Control Configuration of Information Processing System X]

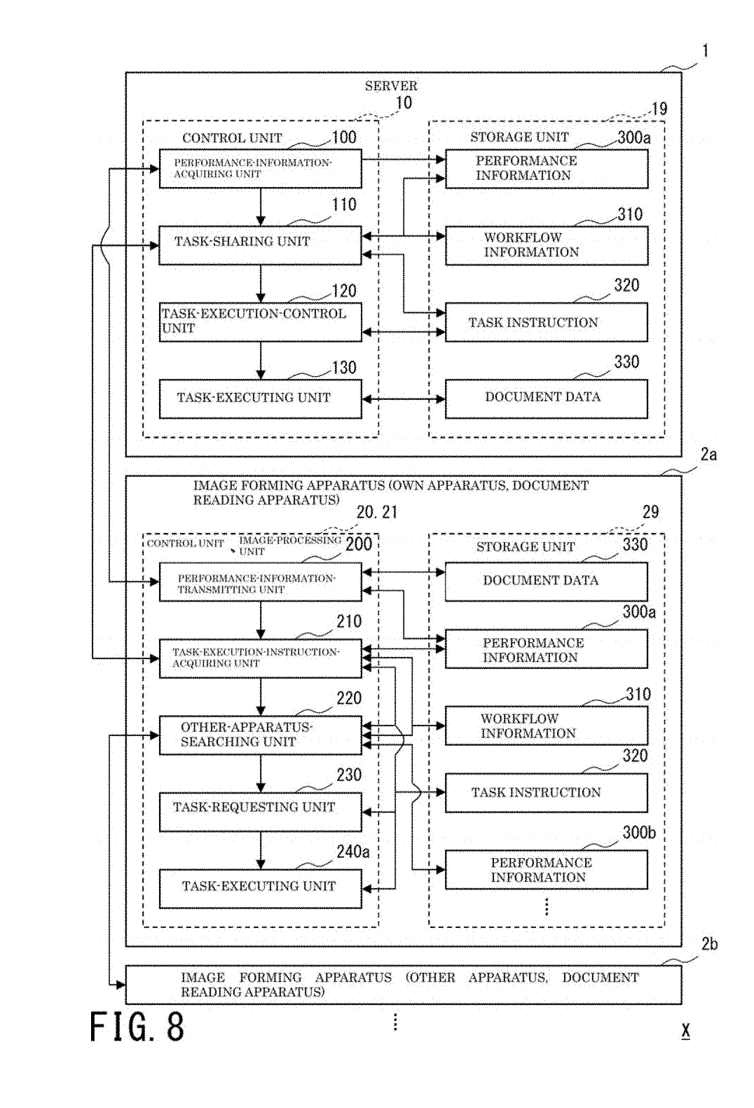

Here, the control configuration of information processing system X of a second embodiment according to the present disclosure will be explained with reference to FIG. 8.

In the following, as an example of information processing system X, an example will be explained in which information processing system X includes a server 1, and image forming apparatuses 2, 2b (document reading apparatuses), and performs process of a workflow of a series of tasks. Moreover, in this embodiment, the image forming apparatus 2a is taken to be the “own apparatus” that receives an instruction from a user related to a workflow, and shares and executes tasks with the server 1 and the “other apparatus” image forming apparatus 2b.

Even though the image forming apparatus 2a and the image forming apparatus 2b may have different performance or functions, the image forming apparatus 2a and the image forming apparatus 2b may have the same control configuration.

The control unit 10 of the server 1 includes a performance-information-acquiring unit 100, a task-sharing unit 110, a task-execution-control unit 120 and a task-executing unit 130.

The storage unit 19 stores performance information 300a, workflow information 310, task instructions 320, and document data 330 (data of a document).

The control unit 20 and the image-processing unit 21 of the image forming apparatus 2a include a performance-information-transmitting unit 200, a task-execution-instruction-acquiring unit 210, an other apparatus-searching unit 220, a task-requesting unit 230, and a task-executing unit 240a.

The storage unit 29 stores performance information 300a (performance information of the own apparatus), performance information 300b (performance information of the other apparatus), workflow information 310, task instructions 320, and document data 330 (data of a document).

The performance-information-acquiring unit 100 acquires performance information 300a of the image forming apparatus 2a.

Moreover, in this embodiment, the performance-information-acquiring unit 100 acquires document data 330 from the image forming apparatuses 2, and temporarily stores that document data 330 in the storage unit 19. Furthermore, the performance-information-acquiring unit 100 acquires output data and the like of each task of a workflow, and temporarily stores that output data in the storage unit 19.

The task-sharing unit 110, in accordance with the workflow information 310, and in accordance with the performance information 300a that is acquired by the performance-information-acquiring unit 100, determines by which of the server 1, and image forming apparatus 2a, 2b to execute a series of tasks for the document data that is read by the image forming apparatus 2a, and shares execution of the tasks. In other words, the task-sharing unit 110 determines whether to execute a task by the server 1, or to execute the task by the image forming apparatus 2a, or to execute the task by the image forming apparatus 2b, or to execute the task by other image forming apparatus 2, and shares execution of the tasks among these. Moreover, the task-sharing unit 110, according to the performance information 300a, may determine to cause the server 1 to execute tasks that are not mounted in the image forming apparatus 2a, 2b or that have an execution speed that is slower than by the own apparatus. Furthermore, the task-sharing unit 110 may determine to cause image forming apparatus 2a to execute tasks that correspond to functions that are mounted in the image forming apparatus 2a.

The task-execution-control unit 120 performs instruction to cause the server 1 to execute tasks by the task-executing unit 130 for which it has been determined by the task-sharing unit 110 will be executed by the server 1.

Moreover, the task-execution-control unit 120 performs instruction to cause the image forming apparatus 2a to execute tasks by the task-executing unit 240a for which it has been determined by the task-sharing unit 110 will be executed by the image forming apparatus 2a.

Furthermore, the task-execution-control unit 120 performs instruction to cause the image forming apparatus 2b to execute tasks by the task-executing unit 240b for which it has been determined by the task-sharing unit 110 will be executed by the image forming apparatus 2b.

The task-execution-control unit 120 also processes a workflow of a series of tasks by acquiring the output data of each of the tasks that have been executed by the server 1, the image forming apparatus 2a and the image forming apparatus 2b, delivering that output data as the input data for the next task.

The task-executing unit 130 is an executing unit that executes tasks for which it has been determined by the task-sharing unit 110 will be executed by the server 1, and for which there is an execution by the task-execution-control unit 120.

The performance-information-transmitting unit 200 transmits performance information 300a of the image forming apparatus 2a that is the own apparatus to the server 1 that is an external information processing apparatus that is capable of sharing and executing a workflow of a series of tasks for data of a document.

Moreover, the performance-information-transmitting unit 200 transmits document data 330 that is stored in the storage unit 29 to the server 1.

The task-execution-instruction-acquiring unit 210, in accordance with the performance information 300a of the own apparatus that is transmitted by the performance-information-transmitting unit 200, acquires from the server 1 a task instruction 320 that is an instruction for a task that has been shared with the own apparatus.

The other-apparatus-searching unit 220 references the task instruction 320 that is acquired by the task-execution-instruction-acquiring unit 210 and the workflow information 310, and for tasks that are not shared with the own apparatus, searches whether or not there is an image forming apparatus 2 nearby that is an other apparatus that can be requested to perform execution of the tasks.

In this embodiment, an example is described in which the other-apparatus-searching unit 220 searches for image forming apparatus 2b as the other apparatus. When doing this, the other-apparatus-searching unit 220 may perform a broadcast and acquire performance information of the image forming apparatus 2b or the like that is an other apparatus that replies to the broadcast, then determine whether that other apparatus is able to execute tasks that are shared by the image forming apparatus 2a that is the own apparatus, and when execution is possible, may determine that requesting that other apparatus is possible.

The task-requesting unit 230 requests and shares execution of tasks with the image forming apparatus 2b that was found by the other-apparatus-searching unit 220 and that can be requested to execute tasks.

The task-executing unit 240a is an executing unit that executes task for which it is determined by the task-sharing unit 110 will be executed by the image forming apparatus 2a, and that are shared with and assigned to the own apparatus. When doing this, the task-executing unit 240a executes tasks that were not requested to the other apparatus by the task-requesting unit 230.

The performance information 300a is information related to the performance and functions of the image forming apparatus 2a that is the own apparatus. Information that is related to performance and functions that correspond to the respective processing of image processing, OCR processing, classification processing, and transmission processing is set as performance information 300a. The performance information 300a, for image processing, includes, for example, information such as whether there is a function capable of executing processes such as skipping blank pages, sharing pages, deskewing (automatic skew correction), border removal, contrast adjustment, noise reduction and the like, and information about the processing capacity and performance of those functions. Moreover, the performance information 300a, for OCR processing, includes, for example, information regarding languages for which character recognition is possible, resolution, whether or not there is recognition of handwritten characters, whether or not tables and figures can be recognized, version of the recognition engine, recognition speed and the like. Moreover, the performance information 300a includes as OCR processing, for example, information of whether or not one-dimensional, two-dimensional, and/or color barcodes, dot images and the like can be recognized. Furthermore, the performance information 300a, for classification processing, includes, for example, information regarding whether or not it is possible to classify invoices, slips, billing and the like, acquire items, extract metadata and the like, and when possible, the type and the like. Of these, metadata includes information of whether or not it is possible to acquire information about the customer ID, company name, name, amount of each item, tax, and the like, and when possible the type and the like. Moreover, the performance information 300a, for transmission processing, for example, includes information of the e-mail addresses of users or groups, addresses of a document boxes (folders for saving files, shared folders), or application name, address, account ID and the like of a DMS.

As performance information 300a it is possible to include information on whether the respective processing described above is possible or not depending on the hardware state, differences in versions of firmware, whether or not an application is installed, state of license authorization and the like. In other words, in the case that a function may not be used even though the model of the image forming apparatus 2 itself includes that function, the performance information 300a may include information to that effect.

Moreover, performance information 300a may also include the language setting, model name, serial number, installation location, customer information and other information of the image forming apparatus 2a.

The performance information 300b is information related to the performance and functions of the image forming apparatus 2b that is the other apparatus. The format and the like of the data of performance information 300b may be the same as that of performance information 300a.

The workflow information 310 is information that includes settings for the flow of processing for a “workflow” of a series of tasks for which the user gives an execution instruction. When this workflow is a scanning workflow related to capture of a document, for example, the workflow information 310 includes settings for the order of processing of tasks of image processing, OCR processing, classification processing, transmission process, settings for the parameter of each respective task, and the like. The workflow information 310, for example, may also include a description of these settings in a format such a “macro” or script.

Moreover, in the workflow information 310 it is possible to set from an application or from the server 1 the administrator of the image forming apparatus 1, the administrator of the server 1 and the like.

A task instruction 320 is an instruction that is acquired from the server 1 and is for a task that is shared with and assigned to the image forming apparatus 2a that is the own apparatus. In other words, a task instruction 320 is information that indicates whether or not task of the workflow information 310 or the like is to be executed by the image forming apparatus 2a.

The document information 330 is data that is the target of various processing in the workflow. In this embodiment an example is described in which the document data 330 is image data of a document that is read by the document-reading unit 22 of the image forming apparatus 2a. The image data, for example, may be bitmap data such as BMP and the like, compressed bitmap data such as TIFF, jpg and the like, PDF data and the like. Moreover, the document data 330 may be a collection of image data in page units, and my be data to which various text data or intermediate data are added in accordance to the degree of progress of each of the tasks described above. The document data 330 may also be a collection of plural files instead of a single file. Furthermore, the document data 330 may be PDF data or the like that is saved beforehand in a document box of a user of the user of an image forming apparatuses 2a, 2b or the server 1, or that is acquired from a terminal or the like.

Here, the control unit 10 of the server 1 is made to function as the performance-information-acquiring unit 100, the task-sharing unit 110, the task-execution-control unit 120 and the task-executing unit 130 by executing the control program that is stored in the storage unit 19.

Moreover, the control unit 20 of the image forming apparatus 2a is made to function as the performance-information-transmitting unit 200, the task-execution-instruction-acquiring unit 210, the other-apparatus-searching unit 220, the task-requesting unit 230 and the task-executing unit 240a by executing the control program that is stored in the storage unit 29.

Furthermore, each of the units of the server 1 and the image forming apparatuses 2 described above is a hardware resource for executing the image forming method according to the present disclosure.

### [Task Sharing Execution Process by Information Processing System X]

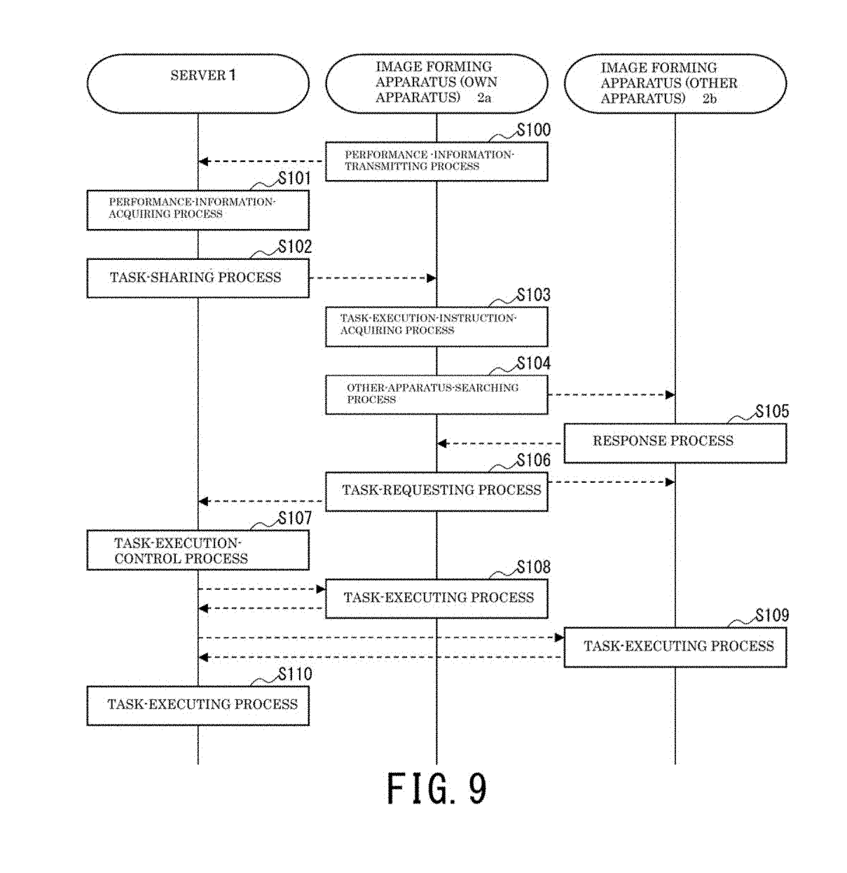

Next, an explanation of the task-sharing-execution process by the information processing system X of a second embodiment according to the present disclosure will be performed with reference to FIG. 9 to FIG. 11.

In the task-sharing-request-execution process of this embodiment, the image forming apparatus 2a is instructed to execute a workflow, and transmits performance information 300a to the server 1. The server 1 acquires the performance information 300a of the image forming apparatus 2. Then, in accordance with the acquired performance information 300a, it is determined for each of the tasks of the workflow for the document data 330 that is read by the image apparatus 2 whether the tasks are to be executed by the server 1 or to be executed by the image forming apparatus, and the tasks are shared and assigned. The server 1, in regard to that sharing of tasks, transmits a task instruction 320 to the image forming apparatus 2a. The image forming apparatus 2a acquires the task instruction 320, and searches whether or not there is a nearby other apparatus that can be requested to perform execution of task that are not shared with and assigned to the own apparatus. In this embodiment, the execution of task is requested, and shared with and assigned to the image forming apparatus 2b that is the other apparatus and that is capable of a request. The image forming apparatus 2a that is the own apparatus executes tasks that are shared and assigned from the server 1 and for which the execution by the image forming apparatus 2b has not been requested. After that, the server 1 executes the tasks for which execution by the server 1 has been determined, and processing is performed as a series of tasks.

In the task-sharing-request-execution process of this embodiment, mainly the control unit 10 executes a program that is stored in the storage unit 19, and the control unit 20 of the image forming apparatus 2a and image-processing unit 21 execute a program that is stored in the storage unit 29, by working together with each of the units and using the hardware resources.

In the following, the task-sharing-request-execution process will be explained in detail for each step with reference to the flowchart in FIG. 9.

### (Step S100)

First, the performance-information-transmitting unit 200 of the image forming apparatus 2a performs a workflow-starting process.

Here, when a user instruction to execute a workflow is acquired from the operation-panel unit 26 of the image forming apparatus 2a or from a terminal, the performance-information-transmitting unit 200 transmits a workflow execution command to the server 1.

The performance-information-acquiring unit 100 of the server 1 acquires an execution command for a workflow, and then instructs the performance-information-transmitting unit 200 of the image forming apparatus 2a to transmit performance information 300a

Moreover, when performing capturing by the image forming apparatus 2a, capturing the document is performed by the document-reading unit 22, and, for example, temporarily stored in the storage unit 29 as document data 300 of bitmap data. This capturing may be performed in parallel with execution of tasks explained below.

### (Step S101)

Next, the performance-information-acquiring unit 100 of the server 1 and the performance-information-transmitting unit 200 of the image forming apparatus 2a perform a performance-information-acquiring process.

The performance-information-transmitting unit 200 of the image forming apparatus 2a acquires the instruction for transmitting the performance information 30a, and then transmits the performance information 300a that is stored in the storage unit 29 to the server 1.

The performance-information-acquiring unit 100 of the server 1 acquires the performance information 300a that is transmitted from the performance-information-transmitting unit 200 of the image forming apparatus 2a, and stores the performance information 300a in the storage unit 19.

### (Step S102)

Next, the task-sharing unit 110 of the server 1 determines whether or not to execute each of the tasks by the server 1. The task-sharing unit 110 references the workflow information 310 and the acquired performance information 300a, and for each task, determines whether or not execution of the task of the workflow can be executed by the image forming apparatus 2a, and determines the execution time, the scale and the type of the task. Then the task-sharing unit 110 determines whether execution would be better by the server 1 or by the other image forming apparatus 2a. Moreover, the task-sharing unit 110, when sharing tasks, may also take into consideration the performance of the server 1 and the image forming apparatus 2, and the transmitting/receiving speed via the network 5.

Moreover, the task-sharing unit 110 may determine according to the performance information 300a to cause the server 1 to execute tasks that are not mounted in the image forming apparatus 2a or that have an execution speed slower than the server 1. More specifically, for tasks that are related to image processing, OCR processing, and transmission processing, and when the image forming apparatus 2a does not have a function that is capable of executing the task, or when the image forming apparatus 2a has that function but is not able to use the function, the task-sharing unit 110 determines to execute the task by the server 1. Moreover, depending processing performance, the transmitting/receiving speed of data, the degree of the processing performance of the server 1 and the like, when executing the task by the server 1 would result in a faster total processing time or higher processing efficiency, the task-sharing unit 110 may determine to execute the task by the server 1.

Furthermore, the task-sharing unit 110 may determine to cause the image forming apparatus 2a to execute tasks that correspond to functions that are mounted in the image forming apparatus 2a. More specifically, for tasks related image processing, OCR processing, and transmission processing, for example, when the image forming apparatus 2a has a function capable of executing the task and is able to use the function, the task-sharing unit 110 determines to execute the task by the image forming apparatus 2a.

When the image forming apparatus 2a has a function that is capable of executing the task, but is unable to use that function, the task-sharing unit 110 may temporarily enable use of the function, and then determine to execute the task by the image forming apparatus 2a. In other words, the task-sharing unit 110 may enable use of the function by temporarily giving license for the application of the image forming apparatus 2a corresponding to that function, or temporarily installing the application itself. After that, after it becomes possible to use the function, the task-sharing unit 110 determines to execute the task by the image forming apparatus 2a.

In the case of a task for which it is determined that the task will be executed by the server 1, the task-sharing unit 110 instructs the task-execution-control unit 120 to execute the task by the server 1. More specifically, for example, the task-sharing unit 110 sets the macro, script or the like of a task command for executing the task by the server 1. When doing this, the task-sharing unit 110 may set this macro or script by including a setting for the input data and output data that corresponds to the various parameters that are included in the workflow information 310, and a setting indicating that the task will be executed by the server 1. Moreover, when doing this, the task-sharing unit 110 may set a “pipe” so that the input data and output data are inputted and outputted in order in accordance with the workflow.

In the case of a task for which it is determined that execution will be performed by the image apparatus 2a, the task-sharing unit 110 instructs the task-execution-control unit 120 so that the task is executed by the image forming apparatus 2a.

The task-sharing unit 110 creates a task instruction 320 as this instruction, and transmits the task instruction 320 to the image forming apparatus 2a. When doing this, the task-sharing unit 110 may also transmit workflow information 310 to the image forming apparatus 2a.

Moreover, in this process as well, the task-sharing unit 110 in addition to including a setting for input data and output data that corresponds to the various parameters that are included in the workflow information 310, and a setting that indicates that execution will be performed by the image forming apparatus 2a, may also set a macro, script or pipe.

### (Step S103)

Here, the task-execution-instruction-acquiring unit 210 of the image forming apparatus 2a performs a task-execution-instruction-acquiring process.

The task-execution-instruction-acquiring unit 210 acquires the task instruction 320 that is transmitted from the server 1, and that is for tasks that are shared with and assigned to the own apparatus.

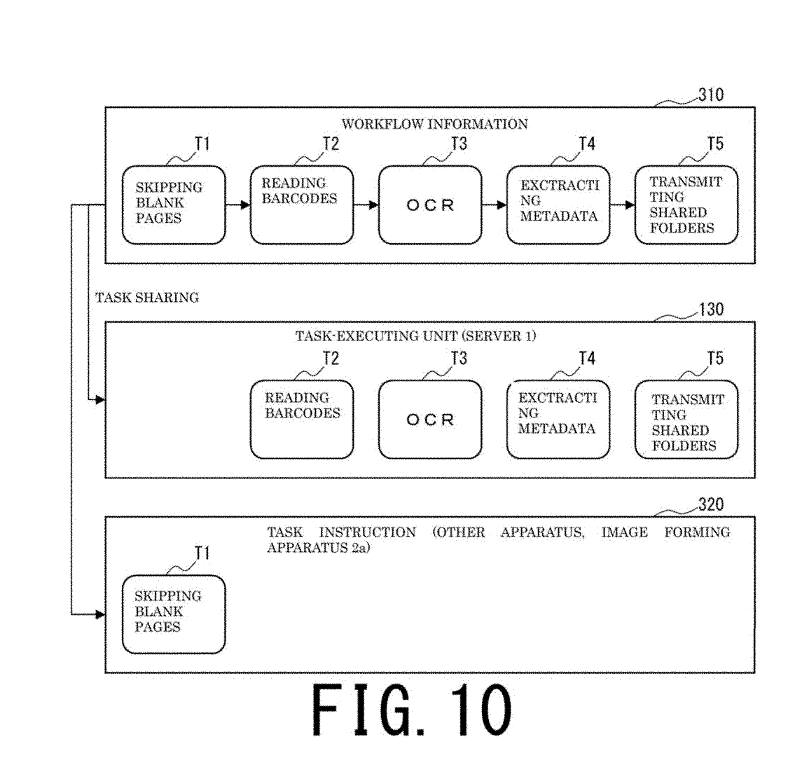

Here, as will be explained using the example in FIG. 10, task T1 to task T5 that are the series included in the workflow information 310 are shared by the server 1 and the image forming apparatus 2a.

In this example, the image forming apparatus 2a is an apparatus that does not have each of the functions of image processing and OCR processing. Therefore, the image forming apparatus 2a receives a task instruction 320 instructing that the image forming apparatus 2a execute only the task T1 of skipping a blank page related to image processing. Then, at this point in time, the task-executing unit 130 of the server 1 waits in order to execute the remaining tasks T2 to T5.

### (Step S104)

Next, the other-apparatus-searching unit 220 performs an other-apparatus-searching process.

First, the other-apparatus-searching unit 220 performs a broadcast, and waits for a response from nearby image forming apparatuses on the network 5.

The other-apparatus-searching unit 220, for example, may use WS-Discovery protocol that uses a SOAP, UDP multicast, and detect the service of an apparatus. In this embodiment, the other-apparatus-searching unit 220 acquires performance information 300b.

### (Step S10)

Here, the image forming apparatus 2b that is an other apparatus executes response processing.

The image forming apparatus 2b causes the performance-information-transmitting unit 200 to transmit performance information 300b stored in the the storage unit 19 to the image forming apparatus 2a.

### (Step S106)

Here, the other-apparatus-searching unit 220 and the task-requesting unit 230 perform a task-requesting process.

The other apparatus-searching unit 220 acquires performance information 300b, and references the task instruction 320 and workflow information 310. Then, the other-apparatus-searching unit 220 determines whether or not it is possible for the image forming apparatus 2b to execute tasks that are not shared with and assigned to the image forming apparatus 2a, and when execution is possible, determines that requesting execution is possible.

The task-requesting unit 230 requests the other apparatus, image forming apparatus 2b, that was determined by the other-apparatus-searching unit 220 to be an apparatus that can be requested to execute a task, to execute that task, and shares and assigns that task to image forming apparatus 2b. In order for this, the task-requesting unit 230 notifies the server 1 that execution of the task has been requested.

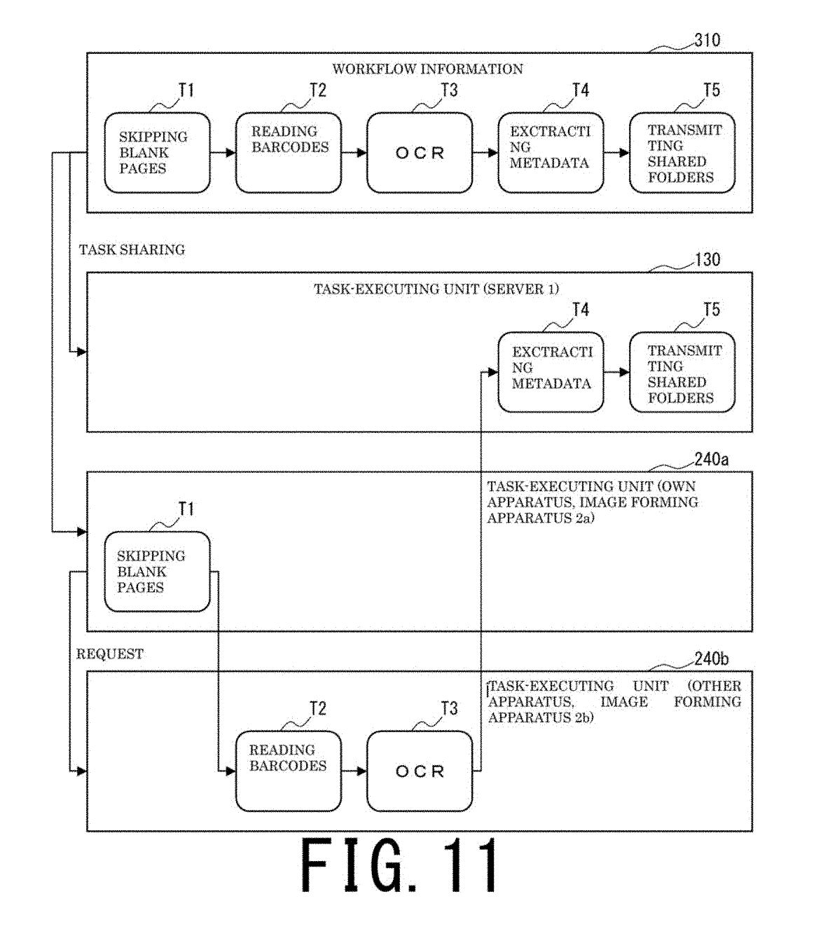

As explained using the example in FIG. 11, for each of the tasks T1 to T5 that are included in the same workflow 310 as in FIG. 10, the series of tasks of the workflow information 310 are shared among the server 1, the image forming apparatus 2a (own apparatus) and the image forming apparatus 2b (other apparatus), execution of the tasks is requested and the tasks are executed.

In this example, the image forming apparatus 2a is a low-function document reading apparatus that is capable of executing only the task of skipping blank pages. Moreover, the image forming apparatus 2b is a high-function apparatus that is capable of using each of the functions of image processing and OCR processing.

Therefore, the task-requesting unit 230 requests the image forming apparatus 2b that is the other apparatus to execute task T2 of reading a barcode, and task T3 of OCR.

### (Step S107)

Here, the task-execution-control unit 120 of the server 1 performs a task-execution-control process.

The task-execution-control unit 120 performs an instruction to cause the tasks that were determined by the task-sharing unit 110 to be executed by the server 1, the image forming apparatus 2a and the image forming apparatus 2b to be executed by the respective apparatuses.

More specifically, for example, the task-execution-control unit 120 issues macro or script commands described above in the order of the settings of the workflow information 310, and distributes execution of the tasks to the server 1, image forming apparatus 2a and image forming apparatus 2b.

### (Step S108)

Here, the task-executing unit 240a of the image forming apparatus 2a performs a task-executing process.

The task-executing unit 240a receives and executes a command for a task that was shared and assigned by the task-sharing unit 110 of the server 1, and was determined to be a task to be executed by the image forming apparatus 2a. In other words, in this case, the task-executing unit 240a executes tasks that were shared with and assigned to the image forming apparatus 2a, and that are not requested to be executed by the other apparatus.

### (Step S109)

Here, the task-executing unit 240b of the image forming apparatus 2b performs a task-executing process.

The task-executing unit 240b executes tasks that are requested by the task-requesting unit 230 to be executed by the image forming apparatus 2b. In this embodiment, the task-executing unit 240b executes commands and the like that are issued by the task-sharing unit 110 of the server 1.

### (Step S110)

Moreover, the task-executing unit 130 of the server 1 performs a task-executing process.

The task-execution-control unit 120 issues commands for tasks that are determined by the task-sharing unit 110 to be tasks that will be executed by the server. Therefore, the task-executing unit 130 executes these tasks.

As a result, document data 330 is processed, and input data and output data are exchanged between the server 1 and the image forming apparatuses 2a, 2b. When doing this, the task-execution-control unit 120, in accordance with the pipe described above, may acquire the execution results of each of the respective tasks, and deliver that output data as input data for the next task. As a result, the task-execution-control unit 120 causes each tasks to be executed as workflow that is a series of tasks. the task-execution-control unit 120 may create temporary files as this input data and output, data, and transmit and receive these files, or may transmit and receive data in specified units such as pages and the like of document data 330.

As explained in the example in FIG. 11, first, task T1 of skipping a blank page related to image processing is executed by the task-executing 240a of the image forming apparatus 2a. As a result, the outputted image data from which blank pages are removed and the like are delivered to the image forming apparatus 2b. When doing this, data may be transferred directly by peer-to-peer, and not via the server 1.

Then, with this image data and the like as input data, task T2 of reading a barcode, and task T3 of OCR that are related to OCR processing are executed in order by the task-executing unit 240b of the image forming apparatus 2b. In this case, task T2 and task T3 may be executed at the same time by multitasking or the like. After execution of task T2 and T3 by the image forming apparatus 2b, an output file of the results is delivered to the task-executing unit 130 of the server 1.

Then, task T4 of extracting metadata, and task T5 of transmitting a shared folder that are related to classification processing are executed in order by the task-executing unit 130 of the server 1.

As a result, by using the server 1, the low-function image forming apparatus 2a and the high-function image forming apparatus 2b, the listed workflow can be executed with higher processing speed and efficiency than when executed by one of these alone.

The execution order and the like of each of the task-executing processes in steps S108 to S110 is just an example, and these task-executing processes can be executed in an arbitrary order according to the form of the workflow, task sharing and task requesting.

Here, the task-sharing-request-execution process of a second embodiment according to the present disclosure ends.

By using the configuration described above, it is possible to obtain the following effects.

In a typical example, the typical technology is distribution technology for saving power, and the waiting time for distributed processing becomes long.

Moreover, in the typical technology, all of the tasks of a workflow can only be executed by the server or by an image forming apparatus, and the waiting time for execution becomes long.

However, the information processing system X of this second embodiment according to the present disclosure includes an image forming apparatus 2a that is the own apparatus of a document reading apparatus, an image forming apparatus 2b that is the other apparatus of a document reading apparatus, and a server 1 that is an information processing apparatus that is capable of receiving data via a network 45 between the image forming apparatuses 2a, 2b.

Moreover, the image forming apparatus 2 includes a performance-information-transmitting unit 200, a task-execution-instruction-acquiring unit 210, an other apparatus-searching unit 220, and a task-executing unit 240a. The performance-information-transmitting unit 200, in accordance with a request from the server 1, transmits performance information 300a of the own apparatus to the server 1 that is capable of sharing and executing a series of tasks for the data of a document. The task-execution-instruction-acquiring unit 210, in accordance with the performance information 300a of the own apparatus that is transmitted by the performance-information-transmitting unit 200, acquires an instruction from the server 1 for tasks that are shared with and assigned to the own apparatus. The other-apparatus-searching unit 220 searches whether or not there are other image forming apparatuses nearby that can be requested to execute the tasks that are shared with and assigned to the own apparatus and that are acquired by the task-execution-instruction-acquiring unit 210. The task-requesting unit 230 requests and shares the execution of tasks with the other apparatus that is found by the other-apparatus-searching unit 220 and that can be requested to execute tasks. The task-executing unit 24a executes the tasks of the tasks shared with and assigned to the own apparatus for which execution is not requested by the task-requesting unit 230.

Moreover, the server 1 includes a performance-information-acquiring unit 100, a task-sharing unit 110, and a task-execution-control 120. The performance-information-acquiring unit 100 acquires performance information 300a of the image forming apparatus 2. The task-sharing unit 110, in accordance with the performance information 300a that is acquired by the performance-information-acquiring unit 100, determines whether a series of tasks for the data of a document that is read by the image forming apparatus 2 will be executed by the own apparatus or executed by the image forming apparatus 2, and shares the tasks. The task-execution-control unit 120 processes tasks as a series of tasks by causing the own apparatus to execute tasks that are determined by the task-sharing unit 110 to be tasks that will be executed by the own apparatus, and causing the image forming apparatus 2 to execute tasks that are determined to be tasks that will be executed by the image forming apparatus 2.

By using this kind of configuration, execution of a series of tasks can be made more efficient, and the waiting time can be reduced. More specifically, the execution time for all of the tasks of the workflow can be faster than when the tasks are executed by the server 1 or by the image forming apparatus 2 alone, and the processing load of the image forming apparatus 2 and the server 1 can be reduced. In other words, the image forming apparatus 2 of this embodiment transmits performance information 300a to the server 1, and searches by WS-Discovery or the like whether or not there are other image forming apparatuses 2 that have performance that the own apparatus does not have. Then, when there is a response from another image forming apparatus, requests that other image forming apparatus to process tasks that cannot be processed by the performance of the own apparatus. As a result, it is possible to improve the availability of the image forming apparatus 2 and server 1 on the network 5.

Furthermore, a feature of the image forming apparatus 2 of this second embodiment of the present disclosure is that an other-apparatus-searching unit 220 performs a broadcast and acquires performance information of a responding other apparatus, determines whether or not the other apparatus is able to execute tasks that are shared with and assigned to the own apparatus, and when execution is possible, determines that the other apparatus can be requested to perform execution.

By using this kind of configuration, it is possible to execute tasks that cannot be executed by the own apparatus by requesting a nearby image forming apparatus 2 to perform execution, and thus a series of tasks can be executed more efficiently, execution can be performed faster than when performing execution by the server 1 or the image forming apparatus 2 alone, and the processing load can be reduced.

### Other Second Embodiment

In a second embodiment according to the present disclosure, sharing and requesting execution of a series of tasks by a server, own apparatus and other apparatus is described, however, depending on the performance of the other apparatus, the entire series of tasks may be executed by one of the apparatuses. In other words, in an environment in which there is only a low-function image forming apparatus 2 that does not even have a function such as skipping blank pages as a function related to image processing, the entire series of tasks may be executed by the server 1. Moreover, in an environment in which there are plural high-function image forming apparatuses 2 that are capable of high-speed execution and can execute all of the functions or image processing, OCR processing, classification processing and transmission processing, the entire series of tasks can be shared, requested and executed by these image forming apparatuses 2.

By using this kind of configuration, a series of tasks can be executed with optimum efficiency and speed according to the environment of the server, own apparatus and other apparatus.

Moreover, in the second embodiment described above, the image forming apparatus 2a was described as being the own apparatus, and the image forming apparatus 2b is described as being the other apparatus, however, the embodiment is not limited to this. In other words, configuration is also possible in which the execution of tasks is requested by taking the image forming apparatus 2b to be the own apparatus and taking the image forming apparatus 2a to be the other apparatus.

Furthermore, in the example above, an example was described in which the server 1 controls the execution of tasks. However, in the case of requested tasks, the image forming apparatus 2a that is the own apparatus may directly perform control of the execution of tasks by the image forming apparatus 2b.

Moreover, the image forming apparatus 2a that is the own apparatus may directly transmit output data to the image forming apparatus 2b that is the other apparatus.

Furthermore, conversely, the image forming apparatus 2a may temporarily acquire input data for a task from the server 1 that is an information processing apparatus, and transmit that input data to the image forming apparatus 2b that is the other apparatus. In this case, the image forming apparatus 2b may transmit output data to the image forming apparatus 2a, and may transmit that output data to the server 1.

Moreover, in the second embodiment described above, configuration was described in which there was one own apparatus and one other apparatus, however, there may be plural other apparatuses.

In this case, even though a function may be mounted in the own apparatus, when another apparatus having high performance is found, execution by the apparatus having the higher performance may be requested. Furthermore, conversely, regardless of any difference in the performance, it is possible to distribute and request execution of tasks by the own apparatus and other apparatus.

Moreover, in the second embodiment described above, an image forming apparatus 2a was described that first transmits performance information 300a to the server 1, and by referencing an acquired task instruction 320 and acquired workflow information 310, searches for and finds another apparatus that can be requested to execute tasks.

However, configuration is also possible in which the own apparatus first searches for and finds another apparatus and then include the requestable performance in the performance information, and transmit that performance information to the information processing apparatus. In other words, the image forming apparatus 2a acquires performance information 300b of the image forming apparatus 2b first, adds the contents to the performance information 300a, then transmits that information to the server 1 and acquires a task instruction 320 based on that information.

By using this kind of configuration, tasks can be flexibly shared and processed efficiently.

### Third Embodiment

### [Configuration of Information Processing System X]

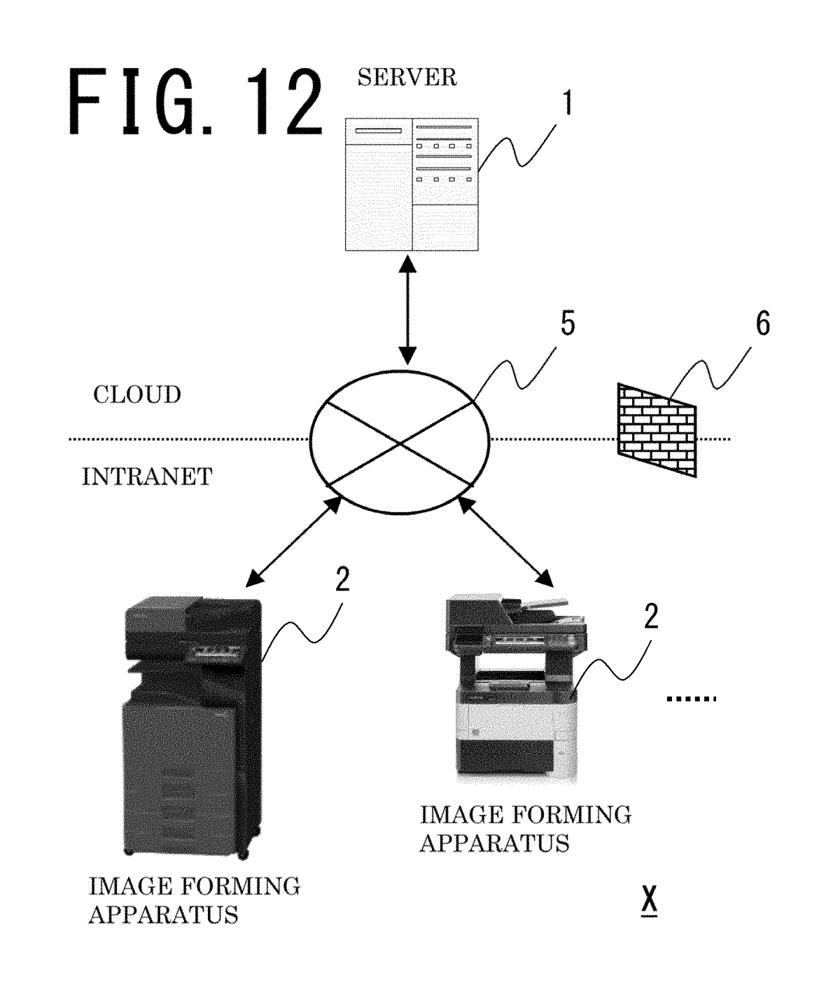

The information processing system X of a third embodiment according to the present disclosure, as illustrated in FIG. 12, as in the case of the information processing system X according to the first embodiment and the second embodiment, includes a server 1 and image forming apparatuses 2 that are connected by a network 5.

In this embodiment, the network 5 includes an intranet that is configured by a LAN, dedicated lines and the like that are capable of transmitting and receiving various kinds of data at high speed, and a so-called “cloud” network such as a WAN and the like of the Internet (registered trademark), portable telephone network and the like.

In this embodiment, an example is explained in which the side of the network where the image forming apparatuses are connected is the intranet side, and the side where the server 1 is connected is the cloud side. In other words, the image forming apparatuses 2 are able to connect to the sever 1 via a router, gateway or the like, and by a specified port and protocol. Moreover, in the network 5 of this embodiment, a global address may be set for the Internet side, and a private address may be set for the local side.

Furthermore, in the network 5 of this embodiment, the intranet side and the cloud side may be divided by a firewall 6 that will be explained below.

The firewall 6 is an apparatus such as a firewall and the like that allows packets or the like of specified ports for which specified rules are set to pass. Moreover, the firewall 6 may be configured as a function of the router or gateway apparatus. Furthermore, the firewall 6 may include functions such as NAT, IP masquerade and the like.

Here, in this embodiment, in typical protocol such as FTP, HTTP and the like, when going through the firewall 6, data may not be able to be transferred from the server 1 on the cloud side to the intranet side even though data can be transferred from the intranet side to the cloud side. In other words, depending on protocol and rules, it may not be possible to specify a specific image forming apparatus 2 or transmitting destination and transfer data from the server 1 even though data can be transferred to the server 1.

Moreover, in this embodiment, when not going through the firewall 6, it is possible to transfer data at high speed from an image forming apparatus 2 to another apparatus within the same intranet. Conversely, when going through the firewall 6, it may not be possible to transfer data even at low speed from the sever 1 on the cloud side, to that other apparatus. In addition, when transferring data to a sever such as a service or the like on the cloud side, the transfer rate of data that is transferred from the server 1 on the cloud side may be faster than that when transferring data from an image forming apparatus 2.

### [Control Configuration of Information Processing System X]

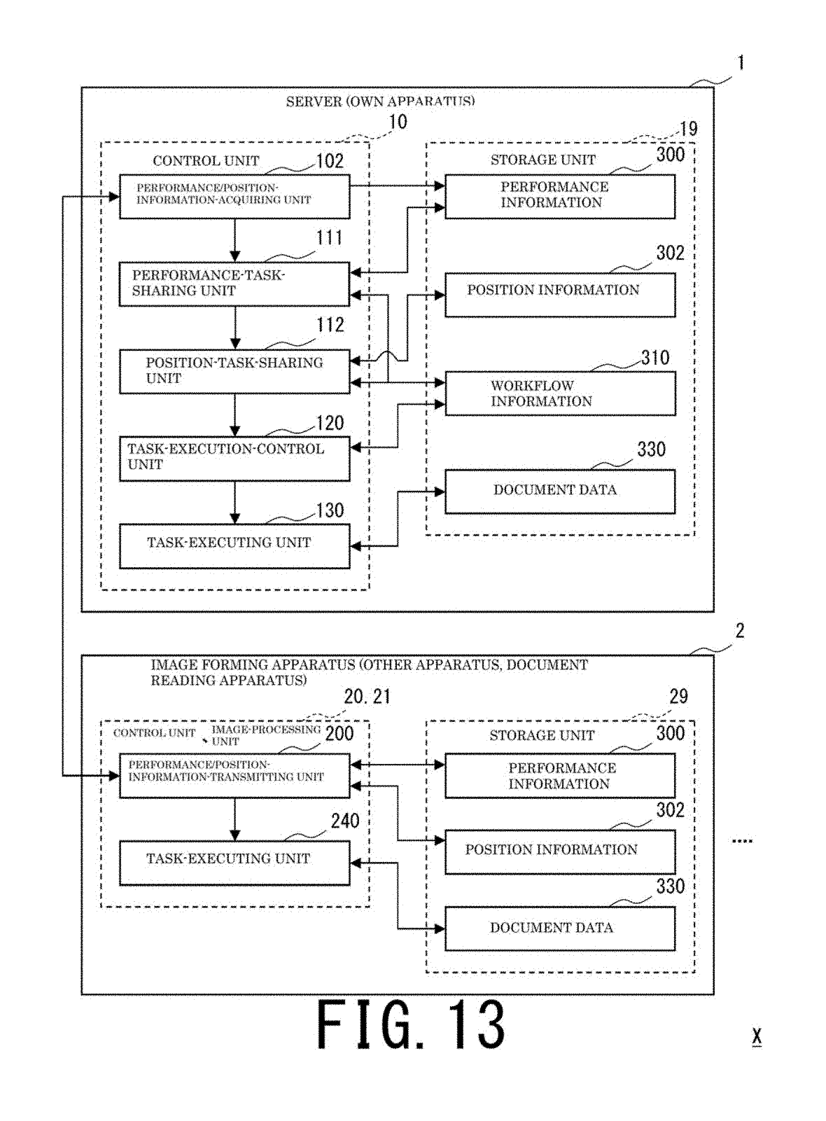

Here, the control configuration of the information processing system X of this third embodiment according to the present disclosure will be explained with reference to FIG. 13.

In the following, an example will be explained in which processing of a workflow of a series of tasks is performed with the server 1 taken to be the “own apparatus”, and image forming apparatus 2 taken to be the “other apparatus” (document reading apparatus).

The control unit 10 of the server 1 includes a performance/position-information-acquiring unit 102, a performance-task-sharing unit 111, a position-task-sharing unit 112, a task-execution-control unit 120, and a task-executing unit 130.

The storage unit 19, stores performance information 300, position information 302, and document data 330 (data of a document), and stores workflow information 310.

The control unit 20 and the image-processing unit 21 of the image forming apparatus 2 include a performance/position-information-transmitting unit 202, and task-executing unit 240.

The storage unit 29 stores performance information 300, position information 302, and document data 330 (data of a document).

The performance/position-information-acquiring unit 102, acquires performance information 300 and position information 302 of the image forming apparatus 2.

Moreover, in this embodiment, the performance/position-information-acquiring unit 102 is able to acquire document data 330 from the image forming apparatus 2, and temporarily store that document data 330 in the storage unit 19. Furthermore, the performance/position-information-acquiring unit 102 may acquire output data and the like of each task of the workflow from the image forming apparatus 2 and temporarily store that output data in the storage unit 19.

The performance-task-sharing unit 111, in accordance with the performance information 300 that is acquired by the performance/position-information-acquiring unit 102, determines which of the tasks of the series of tasks that are set in the workflow information 310 other than for transmission processing are to be executed by the server 1 and which are to be executed by the image processing apparatus 2, and shares the tasks.

Moreover, the performance-task-sharing unit 111, according to the performance information 300, may determine to cause the server 1 to execute tasks that are not mounted in the image forming apparatus 2 or that have an execution speed that is slower than by the server 1. Furthermore, the performance-task-sharing unit 111 may determine to cause the image forming apparatus 2 to execute tasks that correspond to a function that is mounted in the image forming apparatus 2.

The position-task-sharing unit 112, based on the position information that is acquired by the performance/position-information-acquiring unit 102, and in accordance with the position of the transmission destination on the network 5, determines which of the tasks of the series of tasks that are set in the workflow information 310 for transmission processing are to be executed by the server 1 and which are to be executed by the image processing apparatus 2, and shares the tasks.

Moreover, the position-task-sharing unit 112, may cause the image forming apparatus 2 to execute tasks for transmission processing when the transmission destination is on the intranet side (within the intranet) of the network 5 where the image forming apparatus 2 is positioned. Furthermore, the position-task-sharing unit 112 may determine to cause an apparatus that is capable of transmission with optimum routing corresponding with the network structure to execute tasks for transmission processing when the transmission destination is on the cloud side of the network 5.

In other words, the performance-task-sharing unit 111 and the position-task-sharing unit 112 determine whether to cause a task to be executed by the server 1 or executed by the image forming apparatus 2 for each of the respective tasks of the series of tasks, and shares and assigns the execution of that task to one of the apparatuses.

The task-execution-control unit 120 causes the apparatus to which execution has been shared by the performance-task-sharing unit 111 to execute tasks other than tasks for transmission processing, causes the apparatus to which execute has been shared by the position-task-sharing unit 112 to execute tasks for transmission processing, and processes the tasks as a series of tasks that are set in the workflow information 310.

In other words, the task-execution-control unit 120 performs instruction causing the tasks that the performance-task-sharing unit 111 or the position-task-sharing unit 112 have determined will be executed by the server 1 to be executed by the server 1 by the task-executing unit 130.

Moreover, the task-execution-control unit 120 performs instruction causing the tasks that the performance-task-sharing unit 111 or the position-task-sharing unit 112 have determined will be executed by the image forming apparatus 2 to be executed by the image forming apparatus 2 by the task-executing unit 240.

Furthermore, the task-execution-control unit 120 acquires output data of each of the tasks that are executed by the server 1 or the image forming apparatus 2 and delivers that output data as input data for the next task, and processes the tasks as a series of tasks.

The task-executing unit 130 is an executing unit that executes tasks that the performance-task-sharing unit 111 or the position-task-sharing unit 112 have determined will be executed by the server 1, and for which there is an executing instruction by the task-execution-control unit 120.

The performance/position-information-transmitting unit 202, in accordance with a request from the server 1, transmits performance information 300 of the image forming apparatus 2, and position information 302 indicating the position on the network 5 to the server 1.

Moreover, the performance/position-information-transmitting unit 202 transmits document data 330 that is stored in the storage unit 29 to the server 1.

The task-executing unit 240 is an executing unit that executes tasks that the performance-task-sharing unit 111 or the position-task-sharing unit 112 have determined will be executed by the image forming apparatus 2, and for which there is an executing instruction by the task-execution-control unit 120 of the server 1.

The performance information 300 is information related to the performance and functions of the image forming apparatus 2. Information that is related to performance and functions that corresponds to the respective processing of image processing, OCR processing, classification processing, and transmission processing is set as performance information 300. The performance information 300, for image processing, includes, for example, information such as whether there is a function capable of executing processes such as skipping blank pages, sharing pages, deskewing (automatic skew correction), border removal, contrast adjustment, noise reduction and the like, and information about the processing capacity and performance of those functions. Moreover, the performance information 300, for OCR processing, includes, for example, information regarding languages for which character recognition is possible, resolution, whether or not there is recognition of handwritten characters, whether or not tables and figures can be recognized, version of the recognition engine, recognition speed and the like. Moreover, the performance information 300 includes as OCR processing, for example, information of whether or not one-dimensional, two-dimensional, and/or color barcodes, dot images and the like can be recognized. Furthermore, the performance information 300, for classification processing, includes, for example, information regarding whether or not it is possible to classify invoices, slips, billing and the like, acquire items, extract metadata and the like, and when possible, the type and the like. Of these, metadata includes information of whether or not it is possible to acquire information about the customer ID, company name, name, amount of each item, tax, and the like, and when possible the type and the like. Moreover, the performance information 300, for transmission processing, for example, includes information of the e-mail addresses of users or group, addresses of document boxes (folders for saving files, shared folders), or application name, address, account ID and the like of a DMS.

As performance information 300 it is possible to include information on whether the respective processing described above is possible or not depending on the hardware state, differences in versions of firmware, whether or not an application is installed, state of license authorization and the like. In other words, in the case that a function may not be used even though the model of the image forming apparatus 2 itself includes that function, the performance information 300 may include information to that effect.

Moreover, performance information 300 may also include the language setting, model name, serial number, installation location, customer information and other information of the image forming apparatus 2.

The position information 302 is information that indicates the position of the image forming apparatus 2. The position information 302, for example, may be information that indicates the position in the network 5. More specifically, as position information 302 an IP address, subnet mask or the like may be used, and the position information 302 may indicted whether the position is on the intranet side or on the cloud side in the example in FIG. 1.

As position information 302, information such as coordinates like the longitude and latitude or the like of the actual installation position of the image forming apparatus 2, the floor, room or the like in a building, and the like may be used. Moreover, the position information 302 may include transfer rates of data between the image forming apparatus 2 and other apparatuses on the network, between the intranet and cloud, between cloud and cloud. Furthermore, as position information 302, information of the relative position on a distance map based on the topology of the network 5 may be used. Moreover, as position information 302, information of a position that is according to the type of user or group of the image forming apparatus 2 may be used.

The workflow information 310 is information that includes settings for the flow of processing for a “workflow” of a series of tasks for which the user gives an execution instruction. When this workflow is a scanning workflow related to capture of a document, for example, the workflow information 310 includes settings for the order of processing of tasks of image processing, OCR processing, classification processing, transmission process, settings for the parameter of each respective task, and the like. The workflow information 310, for example, may also include a description of these settings in a format such a “macro” or script.

Moreover, in the workflow information 310 it is possible to set from an application or from the server 1 the administrator of the image forming apparatus 1, the administrator of the server 1 and the like.

The document information 330 is data that is the target of various processing in the workflow. In this embodiment an example is described in which the document data 330 is image data of a document that is read by the document-reading unit 22 of the image forming apparatus 2. The image data, for example, may be bitmap data such as BMP and the like, compressed bitmap data such as TIFF, jpg and the like, PDF data and the like. Moreover, the document data 330 may be a collection of image data in page units, and my be data to which various text data or intermediate data are added in accordance to the degree of progress of each of the tasks described above. The document data 330 may also be a collection of plural files instead of a single file. Furthermore, the document data 330 may be PDF data or the like that is saved beforehand in a document box of a user of the user of the image forming apparatus 2 or the server 1, or that is acquired from a terminal or the like.

Here, the control unit 10 of the server 1 is made to function as the performance/position-information-acquiring unit 102, performance-task-sharing unit 111, position-task-sharing unit 112, task-execution-control unit 120, and task-executing unit 130 by executing the control program that is stored in the storage unit 19.

Moreover, the control unit 20 of the image forming apparatus 2 is made to function as the performance/position-information-transmitting unit 202 and the task-executing unit 240 by executing the control program that is stored in the storage unit 29.

Furthermore, each of the units of the server 1 and image forming apparatus 2 described above are hardware resources that execute the image forming method according to the present disclosure.

[Task-performance/position-sharing-execution Process by Information Processing System X]

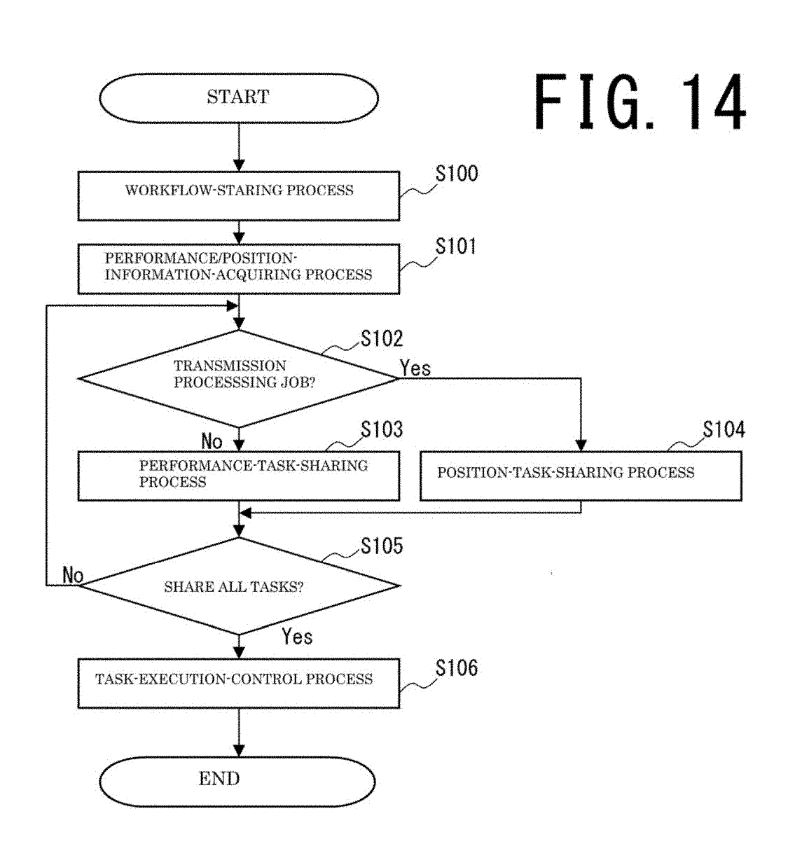

Next, an explanation of the task-performance/position-sharing-execution process by information processing system X of this third embodiment according to the present disclosure will be performed with reference to FIG. 14.

In the task-performance/position-sharing-execution process of this embodiment, the server 1 acquires performance information 300 and position information 302 of the image forming apparatus 2. Then, in accordance with the acquired performance information 300, which of the tasks of the tasks set in the workflow information 310 that are not for transmission processing for the document data 330 that is read by the image forming apparatus 2 will be executed by the server 1 and which will be executed by the image forming apparatus 2 is determined, and the tasks are shared and assigned. Moreover, based on the position information, and correspond to the position on the network 5 of the transmission destination, which of the tasks for transmission processing will be executed by the server 1 and which will be executed by the image forming apparatus 2 is determined, and the tasks are shared and assigned. After that, the server 1 is caused to execute the tasks that have been determined to be executed by the server 1, and the image forming apparatus 2 is caused to execute the tasks that have been determined to be executed by the image forming apparatus 2, and the tasks are processed as a series of tasks. In the task-performance/position-sharing-execution process of this embodiment, mainly the control unit 10 executes a program that is stored in the storage unit 19, and the control unit 20 and image-processing unit 21 execute a program that is stored in the storage unit 29, by working together with each of the units and using the hardware resources.

In the following, the task-performance/position-sharing-execution process will be explained in detail for each step with reference to the flowchart in FIG. 14.

### (Step S100)

First, the performance/position-information-transmitting unit 202 of the image forming apparatus 2 performs a workflow-starting process.

Here, when a user instruction to execute a workflow is acquired from the operation-panel unit 26 of the image forming apparatus 2 or from a terminal, the performance/position-information-transmitting unit 202 transmits a workflow execution command to the server 1.

Moreover, when performing capturing by the image forming apparatus 2, capturing the document is performed by the document-reading unit 22, and temporarily stored in the storage unit 29 as document data 330 of bitmap data. This capturing may be performed in parallel with execution of tasks explained below.

### (Step S101)

Next, the performance/position-information-acquiring unit 102 of the server 1 and the performance/position-information-transmitting unit 202 of the image forming apparatus 2 perform a performance/position-information-acquiring process.

The performance/position-information-acquiring unit 102 of the server 1 acquires a workflow execution command, and then instructs the performance/position-information-transmitting unit 202 of the image forming apparatus 2 to transmit performance information 300 and position information 302.

The performance/position-information-transmitting unit 202 of the image forming apparatus 2 acquires that instruction and transmits the performance information 300 and position information 302 that is stored in the storage unit 29 to the server 1.

The performance/position-information-acquiring unit 102 of the server 1 acquires the performance information 300 and position information 310 that is transmitted from the performance/position-information-transmitting unit 202 of the image forming apparatus 2, and stores the performance information 300 and position information 302 in the storage unit 19.

### (Step S102)

Next, the performance-task-sharing unit 111 and the position-task-sharing unit 112 of the server 1 determines for each task whether or not the task is a transmission task. When a task is a transmission task, the position-task-sharing unit 112 determines YES. When a task is not a transmission task, the performance-task-sharing unit 111 determines NO.

In the case of YES, the position-task-sharing unit 112 advances the process to step S104.

In the case of NO, the performance-task-sharing unit advances the process to step S103.

### (Step S103)

When a task is not a transmission task, the performance-task-sharing unit 111 performs a performance-task-sharing process.

The performance-task-sharing unit 111 determines for each task whether or not to cause the task to be executed by the server 1. The performance-task-sharing unit 111 and the position-task-sharing unit 112 reference the workflow information 310 and the acquired performance information 300, determine for each task whether or not it is possible to execute each task in the workflow by the image forming apparatus 2, determine the extent of the execution time, scale and type of the task, and determine whether it would be better to execute the task by the server 1 or the other apparatus. When performing this sharing of tasks, the performance-task-sharing unit 111 may also take into consideration the performance of the server 1 and the image forming apparatus 2, and the transmitting/receiving speed of data via the network 5.

Moreover, when doing this, the performance-task-sharing unit 111 may determine, according to the performance information 300, whether to cause the server 1 to execute tasks that are not mounted in the image forming apparatus 2 or that have a slower execution speed than the server 1. More specifically, the performance-task-sharing unit 111, for example, determines for tasks related to image processing and OCR processing to execute a task by the server 1 when the image forming apparatus 2 does not have a function capable of executing that task or when the image forming apparatus 2 has that function but is not able to use the function. Moreover, the performance-task-sharing unit 111 may determine according to the extent of the processing performance, the transmitting/receiving speed of the data, the performance of the server 1 and the like to execute a task by the server 1 when the total processing time or the processing efficiency increases when the task is executed by the server 1.

Furthermore, the performance-task-sharing unit 111 may determine to cause the image forming apparatus 2 to execute tasks that correspond to functions that are mounted in the image forming apparatus 2. More specifically, the performance-task-sharing unit 111, for tasks related to image processing and OCR processing, for example, determines to execute a task by the image forming apparatus 2 when the image forming apparatus 2 has a function capable of executing that task.

When the image forming apparatus 2 has a function that is capable of executing that task however is not able to use that function, the performance-task-sharing unit 111 may temporarily allow use of the function, and then determine to execute the task by the image forming apparatus 2. In other words, the performance-task-sharing unit 111 may give temporary license for using the application of the image forming apparatus 2 that corresponds to that function, or temporarily install the application itself, and allow use of the function. Then, when it is possible to use that function, the performance-task-sharing unit 111 determines to execute the task by the image forming apparatus 2.

In the case of a task for which it is determined that execution will be performed by the server 1, the performance-task-sharing unit 111 instructs the task-execution-control unit 120 to execute that task. More specifically, for example, the performance-task-sharing unit 111 sets a macro, script or the like of a task command for executing that task by the server 1. Moreover, when doing this, the performance-task-sharing unit 111 may set this macro or script with setting of the input data and output data that are correspond to various kinds of parameters that are included in the workflow information 310 and setting indicating that execution will be performed by the server 1 are included. Moreover, when doing this, the performance-task-sharing unit 111 may set a “pipe” as a macro or script setting so that the input data and output data are inputted and outputted in order in accordance with the workflow.

In the case of a task for which it is determined that execution will be performed by the image forming apparatus 2, the performance-task-sharing unit 111 instructs the task-execution-control unit 120 to execute the task by the image forming apparatus 2. In this process as well, the performance-task-sharing unit 111 may set a macro, script or pipe that incudes a setting for the input data and output data that corresponds to the various parameters that are included in the workflow information 310, and a setting indicating that the task will be executed by the other apparatus.

### (Step S104)

When a task is a transmission task, the position-task-sharing unit 112 performs a position-task-sharing process.

The position-task-sharing unit 112, based on position information 302 that is acquired by the performance/position-information-acquiring unit 102, and in accordance with the position on the network of the transmission destination of transmission processing, determines whether to cause a task to be executed by the server or the image forming apparatus 2, and shares and assigns the task. More specifically, the position-task-sharing unit 112 references the position information 302, and grasps the relationship on the network 5 of the transmission destination, the image forming apparatus 2 and the server 1. After that, when, for example, the transmission destination of the task of transmission processing is on the intranet side of the network 5 where the image forming apparatus is positioned, the position-task-sharing unit 112 causes the image forming apparatus 2 to execute the task.

When it is possible to transfer data via a firewall 6 even though the transmission destination of a task of transmission processing is on the intranet side, the position-task-sharing unit 112 may cause the server 1 to execute the task. When, for example, in a situation in which the server 1 is executing the previous task, and after, when execution by the server 1 is more efficient than transmitting to the transmission destination by transferring data each time to the image forming apparatus 2, the position-task-sharing unit causes the server to execute that task of transmission processing.

Moreover, when the transmission destination of a task of transmission processing is on the cloud side, the position-task-sharing unit 112 causes the apparatus that is capable of transmission with the optimum routing corresponding to the network structure to execute the task. More specifically, when the server 1 that is connected to a wide area network is able to transfer data at high speed to a service server of the transmission destination, the position-task-sharing unit 112 may cause the server 1 to execute that task of transmission processing. Furthermore, in the case of an environment that will charge for data-communication expenses when data is transmitted to the cloud side from the intranet side, the position-task-sharing unit 112 may cause that transmission task to be executed by the server 1 on the cloud side.

### (Step S105)

Next, the performance-task-sharing unit 111 and position-task-sharing unit 112 determine whether or not sharing with the own apparatus or other apparatus has been set for all of the tasks. When sharing has been set for all of the tasks, the performance-task-sharing unit 111 and position-task-sharing unit 112 determine YES. Otherwise, in other cases, the performance-task-sharing unit 111 and position-task-sharing unit 112 determine NO.

In the case of YES, the performance-task-sharing unit 111 and position-task-sharing unit 112 advance the process to step S106.

In the case of NO, the performance-task-sharing unit 111 and position-task-sharing unit 112 returns the process to step S102, and shares and assigns the remaining tasks of the workflow in order to cause those tasks to be executed by the server 1 or the image forming apparatus 2.

The processing by these steps S102 to S105 is the task-sharing process of this embodiment.

### (Step S106)

Here, the task-execution-control unit 120 performs a task-executing process.

The task-execution control unit 120 causes tasks other than tasks for transmission processing to be executed by an apparatus to which execution is shared with and assigned to by the performance-task-sharing unit 111. Moreover, the task-execution-control unit 120 causes tasks for transmission processing to be executed by an apparatus to which execution is shared with and assigned to by the position-task-sharing unit 112, and processes tasks as a series of tasks. More specifically, for example, the task-execution-control unit 120 issues the macro or script commands described above in the order of settings in the workflow information 310, and distributes execution of the tasks to be executed by the server 1 or the image forming apparatus 2. For example, the task-execution-control unit 120 issues a task command for a task for which it has been determined by the performance-task-sharing unit 111 or position-task-sharing unit 112 that execution will be performed by the server 1, and causes the server 1 to execute that task by the task-executing unit 130. Moreover, for example, the task-execution-control unit 120 issues a task command for a task for which it has been determined by the performance-task-sharing unit 111 or position-task-sharing unit 112 that execution will be performed by the image forming apparatus 2, and causes the image forming apparatus 2 to execute that task by the task-executing unit 240.

As a result, the document data 330 is processed, and input data and output data are exchanged between the server 1 and the image forming apparatus 2. When doing this, the task-execution-control unit 120, in accordance with the pipe, may acquire output data that is a result of execution of each of the tasks, and deliver that output data as input data for the next task. As a result, the task-execution-control unit 120 causes each of the tasks to be processed as a workflow of a series of tasks. The task-execution-control unit 120 may create and transmit and receive temporary files as this input data and output data, or may transmit and receive data in specified units such as pages or the like of the document data 330.

This ends the task-sharing-execution process of a third embodiment according to the present disclosure.

[Example of the Task-sharing-execution Process]

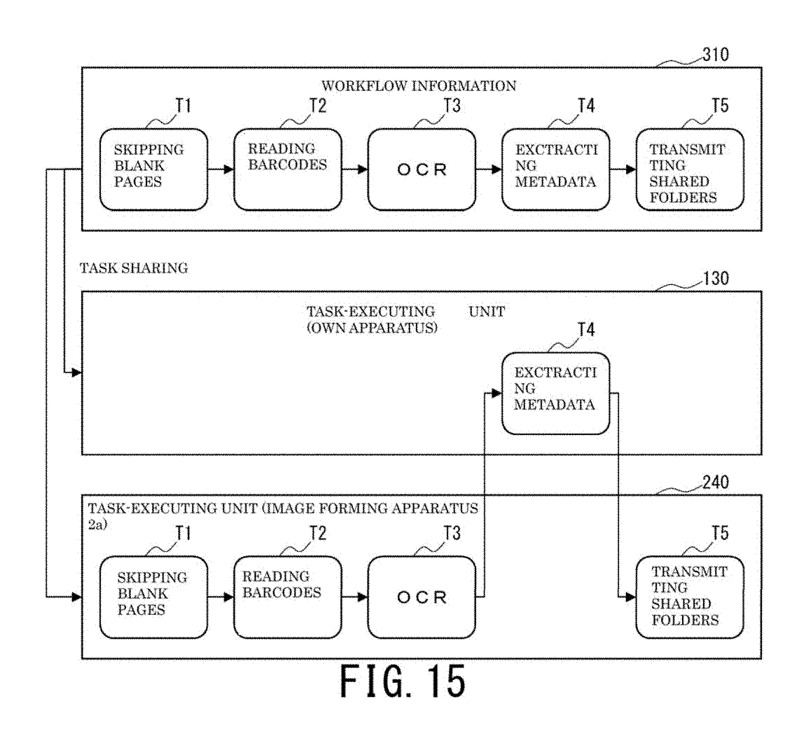

Here, a detailed example of the task-sharing-execution process of the third embodiment according to the present disclosure will be explained with reference to FIG. 15 to FIG. 18.

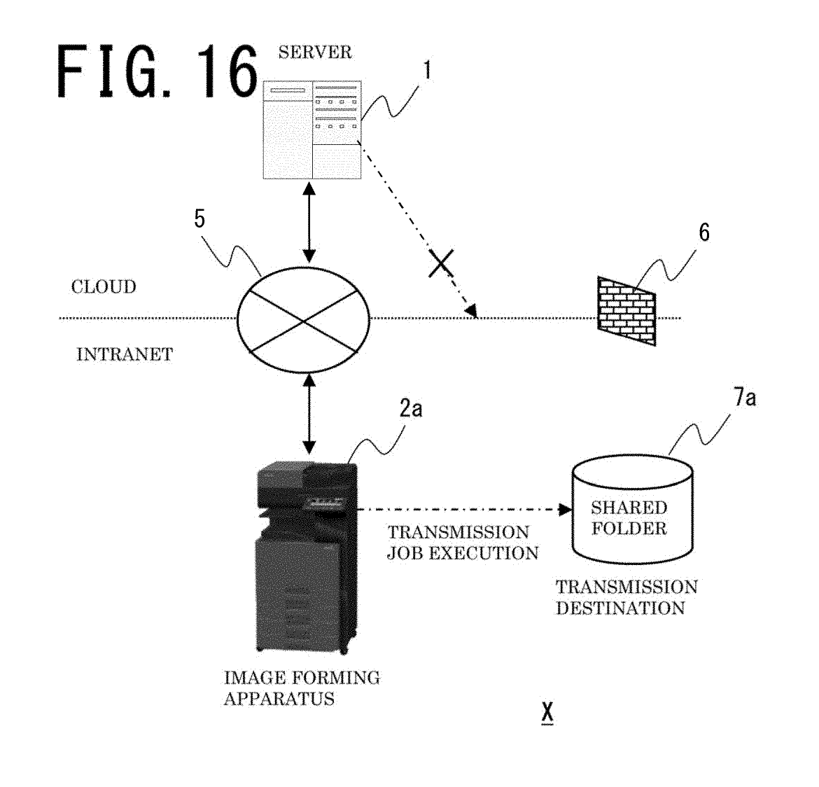

FIG. 15 and FIG. 16 illustrate an example in which, for each of the tasks T1 to T5 that are included in the workflow information 310, the series of tasks of the workflow information 310 are shared and executed by the server 1 (own apparatus) and the image forming apparatus 2a (other apparatus).

In this example, the image forming apparatus 2a is a high-function apparatus that is able to use each function of image processing and OCR processing. Therefore, task T1 of skipping blank pages related to image process, task T2 of reading barcodes, and task T3 of OCR that are related to OCR processing are executed in order by the task-executing unit 240 of the image forming apparatus 2a. In this case, task T2 and task T3 may be executed simultaneously by multitasking or the like.

After execution of task T1 to task T3 by the image forming apparatus 2a is complete, the resulting output file is delivered to the task-executing unit 130 of the server 1. Then, task T4 of extracting metadata that is related to classification processing is executed by the task-executing unit 130 of the server 1.

However, in this example, as illustrated in FIG. 16, the transmission destination 7a of the transmission job is a shared folder such as an NAS or the like on the intranet side, and this shared folder cannot be accessed from the server 1.

Therefore, task T5 of transmitting a shared folder is finally caused to be executed by the image forming apparatus 2a.

As a result, the transmission tasks of the listed workflow can be reliably executed even when the transmission destination 7a is on the intranet side. Moreover, each of the tasks can be performed with increased processing speed and efficiency by using the server 1 and the high-function image forming apparatus 2a than when executed by one of these alone.

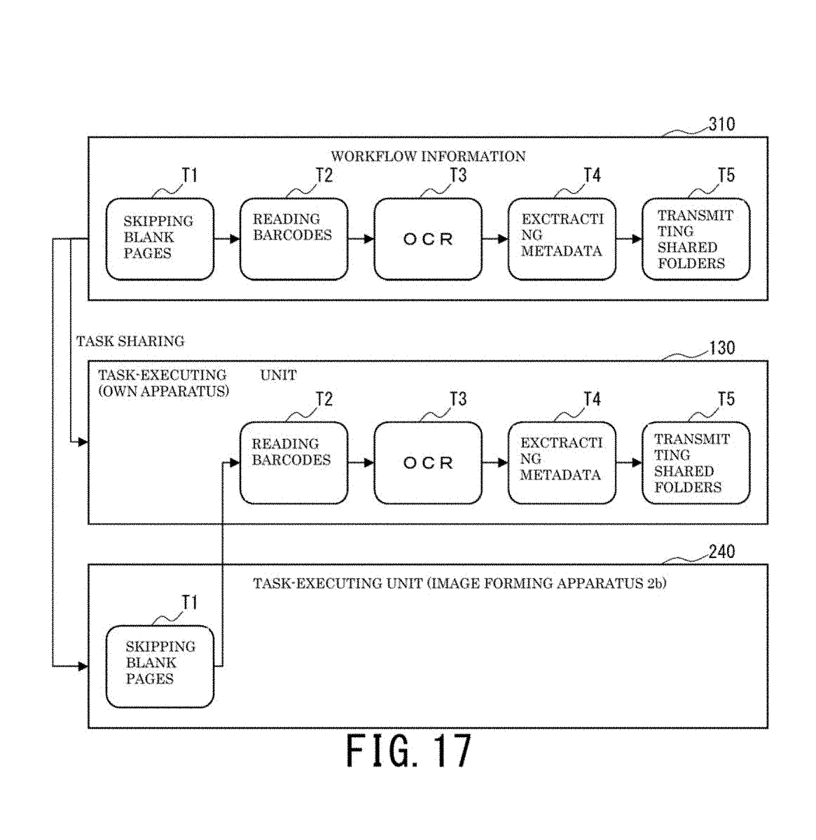

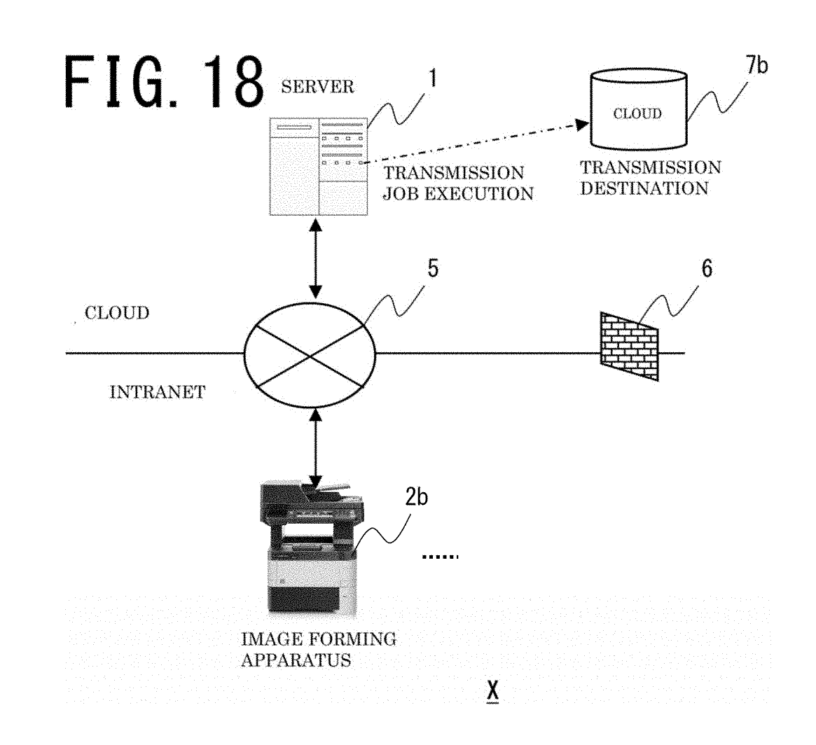

FIG. 17 and FIG. 18 illustrates an example in which, for each of the tasks T1 to T5 that are included in the same workflow as in FIG. 15 and FIG. 16, the series of tasks of the workflow information 310 are shared and executed by the server 1 (own apparatus) and an image forming apparatus 2b (other apparatus).

In this example, the image forming apparatus 2b is an apparatus having lower function than the image forming apparatus 2a, and does not have each function for image processing and OCR processing. Therefore, only task T1 of skipping blank pages related to image process is executed by the image forming apparatus 2b, after which the image data and the like that is outputted is delivered to the task-executing unit 130 of the server 1. The remaining tasks T2 to T5 are then executed in order by the task-executing unit 130 of the server 1.

Here, in this example, as illustrated in FIG. 18, the transmission destination 7b of the transmission job is a server or the like for cloud service on the cloud side. Therefore, by executing a transmission task from the server 1 that is on the cloud side and that is connected to the wide area network, transmission can be performed at high speed.

As a result, even in the case of the low-function image processing apparatus 2b, it is possible to execute the listed workflow with increased processing speed and efficiency while sharing with the server 1.

By using this kind of configuration, it is possible to obtain the following effects.

In conventional technology, depending on the configuration of the network, it is not possible to execute transmission tasks well.

However, the information processing system X of this third embodiment according to the present disclosure includes an image forming apparatus 2 that is a document reading apparatus, and a server 1 that is an information processing apparatus that is capable of transmitting and receiving data to and from that image forming apparatus 2 via a network 5. Moreover, the image forming apparatus 2 includes a performance/position-information-transmitting unit 202 that transmits performance information of the image forming apparatus 2 and position information of the image forming apparatus 2 on the network 5 in accordance with a request from the server 1. Furthermore, the server 1 includes a performance/position-information-acquiring unit 102, a performance-task-sharing unit 111, a position-task-sharing unit 112, and a task-execution-control unit 120. The performance/position-information-acquiring unit 102 acquires the performance information 300 and the position information 302 of the image forming apparatus 2. The performance-task-sharing unit 111, in accordance with the performance information 300 that is acquired by the performance/position-information-acquiring unit 102, determines for the tasks of the series of tasks for the document data 330 that is read by the image forming apparatus 2 that are not transmission processing tasks whether to cause the tasks to be executed by the image server 1 or the image forming apparatus 2, and shares the tasks. The position-task-sharing unit 112, based on the position information 302 that is acquired by the performance/position-information-acquiring unit 102, and in accordance with the position of the transmission destination on the network, determines for the tasks of the series of tasks that are transmission tasks whether to cause the tasks to be executed by the image server 1 or the image forming apparatus 2, and shares the tasks. The task-execution-control unit 120 causes tasks that are not for transmission processing to be executed by an apparatus with which execution is shared and assigned to by the performance-task-sharing unit 111, and causes tasks that are for transmission processing to be executed by an apparatus with which execution is shared and assigned to by the position-task-sharing unit 112.

By using this kind of configuration, it is possible to transmit data of a transmission task with optimum routing that takes into consideration the conditions of the workflow. As a result, it is possible to reliably execute a transmission job.

Moreover, it is possible to make execution of the series of tasks more efficient, and it is possible to reduce the waiting time. More specifically, it s possible to make the execution time of all of the tasks of a workflow faster than when the server 1 or the image forming apparatus 2 executes the tasks alone, and it is possible to reduce the processing load on the image forming apparatus 2 and the server 1.

Furthermore, a feature of the server 1 of this third embodiment according to the present disclosure is that the performance-task-sharing unit 111, according to the performance information 300, causes the server 1 to execute tasks that are not mounted in the image forming apparatus 2, or that have a slower execution speed than by the own apparatus, and then determines to cause the image forming apparatus 2 to execute tasks that correspond to functions that are mounted in the image forming apparatus 2.

By using this kind of configuration, it is possible to make execution of a series of tasks more efficient, and it is possible execute the tasks faster than when executed by the server 1 or by the image forming apparatus 2 alone, and it is possible to reduce the processing load.

Moreover, a feature of the server 1 of this third embodiment according to the present disclosure is that the position-task-sharing unit 112 determines to cause tasks for transmission processing to be executed by the image forming apparatus 2 when the transmission destination is within the intranet where the image forming apparatus 2 is located, and determines to cause those tasks to be executed by an apparatus that is capable of transmission with the optimum routing that corresponds to the network structure when the transmission destination is in the cloud.

By using this kind of configuration, it is possible to reliably and efficiently execute transmission tasks.

### Other Embodiments

In the third embodiment according to the present disclosure, sharing a series of tasks by the own apparatus and the other apparatus was described, however, depending on the performance of the other apparatus, the entire series of tasks may be executed by either of the apparatuses. In other words, in the case of a low-function image forming apparatus, a network scanner or the like that does not have a function such as skipping blank pages as a function related to image processing, the entire series of tasks may be executed by the server. Moreover, in the case of a high-function image forming apparatus that is capable of executing at high speed all of the functions of image processing, OCR processing, classification processing, transmission processing, the entire series of tasks may be executed by the image forming apparatus 2.

By using this kind of configuration, it is possible to execute a series of tasks with optimum efficiency and speed in accordance with the environment of the own apparatus and the other apparatus.

Moreover, in the first and third embodiments described above, the server 1 is described as being the own apparatus, and the image forming apparatus 2 is described as being the other apparatus, however, the embodiment is not limited to this. In other words, configuration is also possible in which performance information 300 is acquired with the image forming apparatus 2 is taken to be the own apparatus and the server 1 is taken to be the other apparatus, and the image forming apparatus 2 shares tasks.

By using this kind of configuration, tasks can be flexibly shared and processed efficiently.

Furthermore, the present disclosure of the first to third embodiments described above can also be applied to a document reading apparatus other than the image forming apparatus 2. Moreover, configuration may also be such that a network 5 is not used, and the document reading apparatus and information processing apparatus are directly connected. In other words, configuration may be such that a server or the like to which a network scanner or scanner are separately connected by USB or the like is used.

By using this kind of configuration, it is possible to reliably execute transmission tasks even in the case of a document reading apparatus that is not an image forming apparatus, and it is possible to share tasks and process tasks efficiently at high speed.

Moreover, in the first to third embodiments above, sharing the tasks of a scanning workflow related to capturing a document was described, however, types of workflows other than this can also be handled. Furthermore, it is also possible to share tasks other than for image processing, OCR processing, classification processing and transmission processing.

By using this kind of configuration, it is possible to reliably execute transmission tasks, and it is possible to flexibly share tasks and process tasks efficiently at high speed.

Moreover, in the first to third embodiments described above, the server 1 may include in addition to the control unit 10, a control-operation unit for executing OCR processing, classification processing and the like at high speed. This control-operation unit may be an ASIC, a DSP, and external accelerator, or the like for executing specific operations of an artificial neural network or the like at high speed.

The configuration and operation of the first to third embodiments described above are examples, and needless to say can be appropriately changed within a range that does not depart from the spirit and scope of the present disclosure.

What is claimed is:

1. An information processing system that includes a document reading apparatus, and an information processing apparatus that is capable of transmitting and receiving data to and from that document reading apparatus, wherein
the document reading apparatus comprises:
a performance-information-transmitting unit that transmits performance information in accordance with a request from the information processing apparatus; and
the information processing apparatus comprises:
a performance-information-acquiring unit that acquires performance information of the document reading apparatus;
a task-sharing unit that, in accordance with the performance information that is acquired by the performance-information-acquiring unit, determines which tasks of a series of tasks for data of a document that is read by the document reading apparatus will be executed by an own apparatus and by the document reading apparatus, and shares the tasks; and
a task-execution-control unit that causes tasks that are determined by the task-sharing unit to be tasks that will be executed by the own apparatus to be executed by the own apparatus, and causes tasks that are determined to be tasks that will be executed by the document reading apparatus to be executed by the document reading apparatus, and processes the tasks as a series of tasks.

2. The information-processing system according to claim 1, wherein
the task-sharing unit determines to cause tasks that correspond to at least one of a function that is not mounted in the document reading apparatus and a function having an execution speed that is slower than the own apparatus to be executed by the own apparatus, and determines to cause tasks that correspond to a function that is mounted in the document reading apparatus to be executed by the document reading apparatus.

3. An information processing system that includes a document reading apparatus that is capable of reading data of a document, and an information processing apparatus that is capable of transmitting and receiving data to and from the document reading apparatus, wherein
the document reading apparatus comprises:
a performance-information-transmitting unit that transmits performance information of an own apparatus to the external information processing apparatus that is capable of sharing and executed a series of tasks for data of the document;
a task-execution-instruction-acquiring unit that, in accordance with the performance information of the own apparatus that is transmitted by the performance-information-transmitting unit, acquires an instruction for the task that is shared with the own apparatus;
an other-apparatus-searching unit that references the instruction for the task that is acquired by the task-execution-instruction-acquiring unit, and searches whether or not there is a nearby other apparatus that can be requested to execute the tasks that are not shared with and assigned to the own apparatus;
a task-requesting unit that requests the requestable other apparatus that is found by the other-apparatus-searching unit to execute tasks, and shares the tasks; and
a task-executing unit that executes tasks that are shared with the own apparatus and that are tasks that the task-executing unit has not requested the other apparatus to execute; and
the information processing apparatus comprises:
a performance-information-acquiring unit that acquires the performance information of the document reading apparatus;
a task-sharing unit that, in accordance with the performance information that is acquired by the performance information of the document reading apparatus, determines which tasks of the series of tasks for data of a document that is read by the document reading apparatus to execute by the own apparatus and by the document reading apparatus, and shares the tasks; and
a task-execution-control unit that causes tasks that are determined by the task-sharing unit to be tasks that will be executed by the information processing apparatus to be executed by the information processing apparatus, and causes tasks that are determined to be tasks that will be executed by the document reading apparatus to be executed by the document reading apparatus, and processes the tasks as a series of tasks.

4. The information processing system according to claim 3, wherein
the other-apparatus-searching unit
performs a broadcast, acquires the performance information of an other apparatus that responds, determines whether or not the other apparatus can executed tasks that are not shared and assigned to the own apparatus, and when execution is possible, determines that the other apparatus can be requested to execute the tasks.

5. An information processing system that includes a document reading apparatus, and an information processing apparatus that is capable of transmitting and receiving data to and from the document reading apparatus; wherein
the document reading apparatus includes a performance/position-information-transmitting unit that, in accordance with a request from the information processing apparatus, transmits performance information of the document reading apparatus, and position information of the document reading apparatus on a network;
the information processing apparatus comprises:
a performance/position-information-acquiring unit that acquires the performance information and the position information of the document reading apparatus;
a performance-task-sharing unit that, in accordance with the performance information that is acquired by the performance/position-information-acquiring unit, determines which tasks of a series of tasks for data of a document that is read by the document reading apparatus that are not for transmission processing are to be executed by an own apparatus and by the document reading apparatus, and shares the tasks;
a position-task-sharing unit that, based on the position information that is acquired buy the performance/position-information-acquiring unit, and in accordance with the position of the transmission destination on the network, determines which of the tasks of the series of task that are for transmission processing are to be executed by the own apparatus and by the document reading apparatus, and shares the tasks; and
a task-execution-control unit that causes the tasks that are not for transmission processing to be executed by an apparatus to which tasks are shared with and assigned to by the performance-task-sharing unit, causes the tasks that are for transmission processing to be executed by an apparatus to which tasks are shared with and assigned to by the position-task-sharing unit, and processes the tasks as a series of tasks.

6. The information processing system according to claim 5, wherein
the performance-task-sharing unit
determines to cause tasks that correspond to at least one of a function that is not mounted in the document reading apparatus and a function having an execution speed that is slower than the own apparatus to be executed by the own apparatus, and determines to cause tasks that correspond to a function that is mounted in the document reading apparatus to be executed by the document reading apparatus.

7. The information processing system according to claim 5, wherein
the position-task-sharing unit
determines to cause the document reading apparatus to execute the tasks for transmission processing by the document reading apparatus when the transmission destination is within the intranet where the document reading apparatus is located, and
determines to cause an apparatus that is capable of transmission by optimum routing corresponding to the structure of the network to execute task when the transmission destination is in a cloud.
